(19) United States
(12) Patent Application Publication
(10) Pub. No.: US 2014/0207929 A1
(43) Pub. Date: Jul. 24, 2014

(54) MANAGEMENT APPARATUS AND MANAGEMENT METHOD

(71) Applicant: ALAXALA Networks Corporation, Kanagawa (JP)

(72) Inventors: Hikaru HOSHINO, Kawasaki (JP); Hiroyasu KIMURA, Kawasaki (JP)

(73) Assignee: ALAXALA Networks Corporation, Kanagawa (JP)

(21) Appl. No.: 14/034,602

(22) Filed: Sep. 24, 2013

(30) Foreign Application Priority Data
Jan. 21, 2013 (JP) 2013-008536

(51) Int. Cl. H04L 12/24

(52) U.S. Cl. CPC H04L 41/06
USPC 709/223

(57) ABSTRACT

A management apparatus includes user group information for managing the terminals by grouping terminals into groups each corresponding to service use conditions of terminals belonging to the group, and service information for associating each of the services provided by the service providing resources with paths for passing data when a terminal uses the service and a failure group which is affected by a failure when the failure occurs in one of the paths. When a failure occurs in one of the paths in the network, the management apparatus refers to the service information to identify a service for which the paths in the service information include the failed path as a failed service, identifies a failure group associated with the identified failed service, refers to the user group information to identify terminals belonging to the identified failure group as failure terminals, and reports the identified failure terminals.

### CLAIM OF PRIORITY

The present application claims priority from Japanese patent application JP2013-008536 filed on Jan. 21, 2013, the content of which is hereby incorporated by reference into this application.

### BACKGROUND

This invention relates to a management apparatus connected via a network.

In a network system, when a failure occurs in a network apparatus or network line, a network management apparatus (management apparatus) identifies the cause and location of the failure and determines the range of information processing terminals (terminals) which use the network system and are affected by the failure based on the identified cause and location.

Traditional network management apparatuses monitor operating conditions of the network system by acquiring state information from the nodes constituting the network system. The traditional network management apparatuses analyze the acquired state information to detect a failure and identify the cause and location of the failure.

For the network management apparatuses to acquire state information, there exist some methods including the following methods: acquiring log information using syslog, acquiring a Trap or information in MIB (Management Information Base) using SNMP (Simple Network Management Protocol), and checking whether the management apparatus can communicate with the network system at predetermined intervals.

The traditional network management apparatuses hold network system information on the connections of the nodes in the network system and network configuration and, upon detection of a failure, determine the range of information processing terminals affected by the failure using the cause and location of the failure and the network system information.

In this technical field, there is a background art reference WO 2009/040876.

WO2009/040876 discloses a network management apparatus that manages network structure information about connections in a computer network and IT job influence information holding influences on IT jobs using network apparatuses initially registered in association with each record of the network structure information. Based on the information, the network management apparatus determines the range of IT jobs affected by a failure in the computer network, changes the configurations of the apparatuses in accordance with the failure, and notifies the network administrator or maintenance company of the failure.

### SUMMARY

The traditional network management apparatuses, however, determine the range of information processing terminals affected by a failure in the network system based on the apparatuses connected from the information processing terminals and the network system information but do not consider the services used by the information processing terminals.

The network management apparatus according to WO 2009/040876 considers IT jobs or services used by information processing terminals, but the IT jobs used by information processing terminals are predefined in IT job influence information. For this reason, if the IT jobs used by the information processing terminals change dynamically, the network management apparatus that has detected a failure cannot identify which information processing terminals are using or may use which IT jobs.

Accordingly, the network management apparatus according to WO 2009/040876 that has detected a failure has a difficulty in identifying only the information processing terminals that are using or may use some IT job as a failure-affected range.

Furthermore, since the network management apparatus according to WO 2009/040876 cannot identify only the information processing terminals that are using or may use an IT job as a failure-affected range, configuration change may be mistakenly applied to the apparatuses in the network, which might secondarily affect information processing terminals that are not actually affected by the failure.

In view of the foregoing problems, an object of this invention is to provide a management apparatus that can identify a service affected by a failure and accurately identify the information processing terminals using the service upon detection of occurrence of the failure in a circumstance where use conditions of services change dynamically.

An aspect of the invention is a management apparatus connected to terminals and service providing resources for providing services to be used by the terminals via a network. The management apparatus includes user group information for managing the terminals by grouping the terminals into groups each corresponding to service use conditions of terminals belonging to the group. The management apparatus includes service information for associating each of the services provided by the service providing resources with paths for passing data when a terminal uses the service and a failure group which is affected by a failure when the failure occurs in one of the paths. When a failure occurs in one of the paths in the network, the management apparatus refers to the service information to identify a service for which the paths in the service information include the failed path as a failed service. The management apparatus identifies a failure group associated with the identified failed service. The management apparatus refers to the user group information to identify terminals belonging to the identified failure group as failure terminals. The management apparatus reports the identified failure terminals.

Advantageous effects acquired by a representative aspect of the invention disclosed in this description can be briefly explained as follows. A management apparatus is provided that can, when occurrence of a failure is detected, identify the service affected by the failure and further, accurately identify information processing terminals that use or may use the service.

Problems, configurations, and effects other than those described above are clarified by the following detailed description of embodiments.

### BRIEF DESCRIPTION OF THE DRAWINGS

FIG. 1 is a configuration diagram of a network system in Embodiment 1;

FIG. 2 is an explanatory diagram of an overall configuration of a management apparatus in Embodiment 1;

FIG. 3 is an explanatory diagram of configuration information in Embodiment 1;

FIG. 4 is an explanatory diagram of user group information in Embodiment 1;

FIG. 5 is an explanatory diagram of action information in Embodiment 1;

FIG. 6 is an explanatory diagram of service information in Embodiment 1;

FIG. 7 is a flowchart of processing of a received information analysis unit in Embodiment 1;

FIG. 8 is a flowchart of processing of a failure range analysis unit in Embodiment 1;

FIG. 9 is a flowchart of processing of an action execution unit in Embodiment 1;

FIG. 10 is a flowchart of processing of a management information update unit in Embodiment 1;

FIG. 11 is a flowchart of outputting a service information entry screen in Embodiment 1;

FIG. 12 is a sequence diagram of authentication of a terminal and assignment of an IP address to the terminal in Embodiment 1;

FIG. 13A is an explanatory diagram of user group information before authentication by an authentication server in Embodiment 1;

FIG. 13B is an explanatory diagram of user group information after authentication by an authentication server but before assignment of an IP address to the terminal in Embodiment 1;

FIG. 13C is an explanatory diagram of user group information after assignment of an IP address to the terminal in Embodiment 1;

FIG. 14 is a configuration diagram of a network system in Embodiment 2;

FIG. 15 is an explanatory diagram of configuration information in Embodiment 2;

FIG. 16 is an explanatory diagram of user group information in Embodiment 2; and

FIG. 17 is an explanatory diagram of service information in Embodiment 2.

### DETAILED DESCRIPTION OF THE EMBODIMENTS

Hereinafter, embodiments of this invention are described in detail with reference to the accompanying drawings. It should be noted that substantially the same components are denoted by the same reference signs and repetitive explanation thereof is omitted.

### Embodiment 1

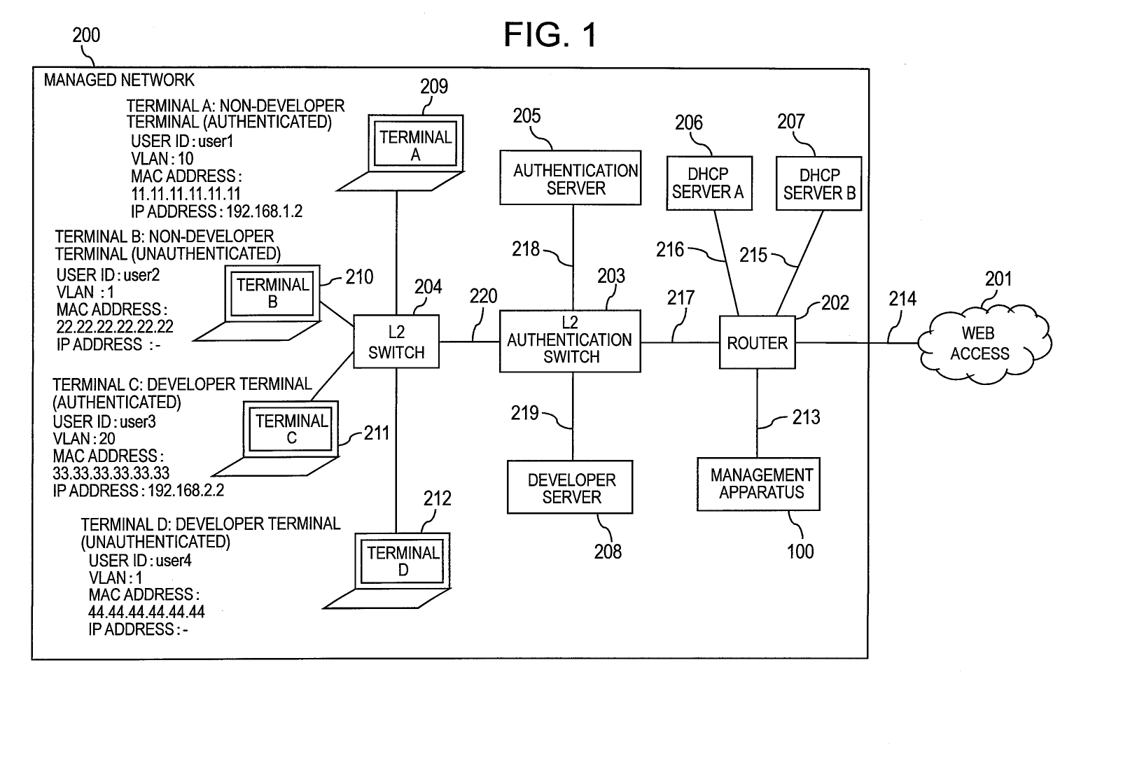

Hereinafter, Embodiment 1 of this invention will be described with FIGS. 1 to 13C.

FIG. 1 is a configuration diagram of a network system in Embodiment 1 of this invention.

The network system includes a managed network 200 and a Web access 201.

The managed network 200 includes a router 202, a management apparatus 100, an L2 (Layer 2) authentication switch 203, an L2 switch 204, a DHCP server A 206, a DHCP server B 207, a developer server 208, an authentication server 205, and a terminal A 209 to a terminal D 212, which are information processing terminals.

The network configuration of the managed network 200 is explained.

The router 202 is connected to the Web access 201 via a connection line 214. The management apparatus 100 is connected to the router 202 via a connection line 213. The L2 switch 203 is connected to the router 202 via a connection line 217. The L2 switch 204 is connected to the L2 authentication switch 203 via a connection line 220. The DHCP server A 206 is connected to the router 202 via a connection line 216. The DHCP server B 207 is connected to the router 202 via a connection line 215. In the following description, each of the DHCP servers A 206 and B 207 is generally referred to as DHCP server. The developer server 208 is connected to the L2 authentication switch 203 via a connection line 219. The terminals A 209 to the terminal D 212 are connected to the L2 switch 204. In the following description, each of the terminals A 209 to D 212 is generally referred to as terminal.

Each apparatus is explained.

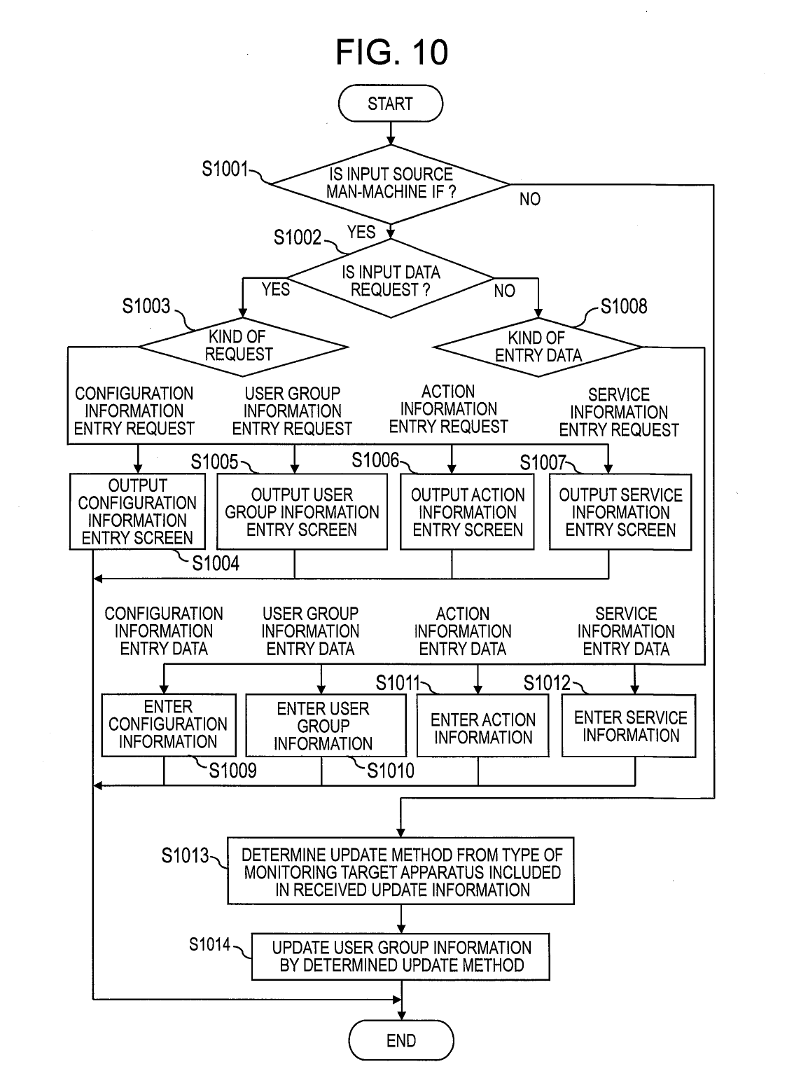

First, the authentication server 205 is explained. The authentication server 205 is a computer to authenticate terminals when the terminals use a VLAN (Virtual Local Area Network). In other words, the authentication server 205 provides a service of authentication to the terminals. The authentication server 205 stores user IDs and passwords to be used to authenticate the terminals, and authentication information indicating the VLAN registered to be used by each authenticated terminal. A terminal sends an authentication request including a user ID and a password to the authentication server 205 and the authentication server 205 that has received the authentication request authenticates the terminal if the user ID and the password included in the authentication request matches the user ID and the password registered in the authentication server 205. Upon authentication by the authentication server 205, the terminal can access the VLAN associated with the user ID. It should be noted that the authentication information stored in the authentication server 205 can be registered or updated only through the management apparatus 100 because the authentication information in the authentication server 205 is synchronized with not-shown authentication information stored in the management apparatus 100. This will be described in detail with FIG. 10.

Next, the terminals are explained. The terminal A 209 and the terminal B 210 are non-developer terminals that cannot access the developer server 208 even if they are authenticated by the authentication server 205; the terminal B 210 has not been authenticated by the authentication server 205 and the terminal A 209 has been authenticated by the authentication server 205. The terminal C 211 and the terminal D 212 are developer terminals that can access the developer server 208 if authenticated by the authentication server 205; the terminal D 212 has not been authenticated by the authentication server 205 and the terminal C 211 has been authenticated by the authentication server 205. The user ID of the terminal A 209 is “User 1” and the MAC address is “11.11.11.11.11.11”. The user ID of the terminal B 210 is “User2” and the MAC address is “22.22.22.22.22.22”. The user ID of the terminal C 211 is “User3” and the MAC address is “33.33.33.33.33.33”. The user ID of the terminal D 212 is “User4” and the MAC address is “44.44.44.44.44.44”.

A VLAN 10 is a network that is not permitted to access the developer server 208 even after authentication by the authentication server 205 and a VLAN 20 is a network that is permitted to access the developer server 208 after authentication by the authentication server 205. A VLAN 1 is a network the terminals unauthenticated by the authentication server 205 belong to. Accordingly, the terminal A 209 which is a non-developer terminal authenticated by the authentication server 205 belongs to the VLAN 10; the terminal C 211 which is a developer terminal authenticated by the authentication server 205 belongs to the VLAN 20; and the terminal B 210 and the terminal D 212 which have not been authenticated by the authentication server 205 belong to the VLAN 1.

Next, DHCP servers are explained. The DHCP servers are servers to assign an IP address to a terminal that has been authenticated by the authentication server 205 responsive to a request from the terminal. In other words, the DHCP servers provide a service of assigning IP addresses to the terminals. The DHCP servers are configured to be redundant with the DHCP servers A 206 and B 207; for example, the DHCP server A 206 works as a master apparatus and the DHCP server B 207 works as a slave apparatus. The IP address assignment to the terminals is performed only by the master apparatus.

A terminal authenticated by the authentication server 205 sends a request for IP address assignment to the DHCP server A 206 and the DHCP server A 206 that has received the request for IP address assignment assigns, in accordance with the VLAN segment of the sender terminal of the request, the terminal of the sender an IP address from an address pool in the DHCP server A 206. In FIG. 1, the terminal A 209 and the terminal C 211 have been authenticated by the authentication server 205 and they are assigned IP addresses by the DHCP server A 206. Specifically, the terminal A 209 is assigned an IP address “192.168.1.2” and the terminal C 211 is assigned an IP address “192.168.2.2”. Since the terminal B 210 and the terminal D 212 are unauthenticated by the authentication server 205, they have not been assigned IP addresses yet.

The developer server 208 is, as mentioned above, a server accessible from developer terminals after authenticated by the authentication server 205 and the users of the developer terminals access the developer server 208 from the developer terminals to develop software. In other words, the developer server 208 provides a service of developing software to the terminals.

The Web access 201 is accessible from the terminals authenticated by the authentication server 205 regardless whether the terminal is a developer terminal or non-developer terminal and enables the terminals to access an external network of the managed network 200. In other words, the Web access 201 provides a service of access to the external to the terminals.

The authentication server 205, the DHCP server A 206, the DHCP server B 207, the developer server 208, and the Web access 201 are to provide some service to the terminals; they are generally referred to as service providing resources.

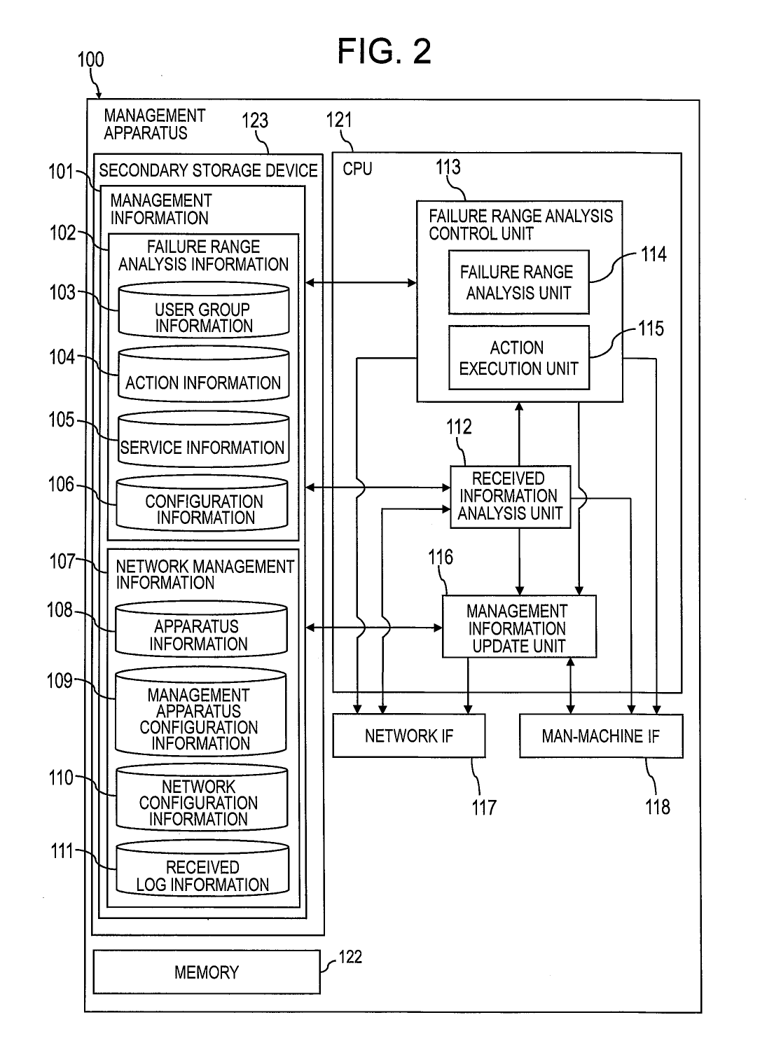

The management apparatus 100 is a computer for managing the network 200 with state information (for example, syslog messages or Traps) acquired from the apparatuses other than the terminals in the managed network 200. The details of the management apparatus 100 will be described with FIG. 2.

FIG. 2 is an explanation diagram of an overall configuration of the management apparatus 100 of this invention.

The management apparatus 100 includes a CPU 121, a memory 122, a secondary storage device 123, a network interface (IF) 117, and a man-machine interface (IF) 118 for hardware components.

The CPU 121 executes programs loaded from the secondary storage device 123 to the memory 122 and refers to information loaded from the secondary storage device 123 to the memory 122. The secondary storage device 123 does not need to be mounted in the same enclosure; for example, it may be connected to the management apparatus 100 via a network. The network IF 117 is an interface to communicate data with an external of the management apparatus 100 and the man-machine IF 118 is an interface to be connected to an input device such as a mouse or a keyboard and an output device such as a display or a printer.

On the CPU 121, a received information analysis unit 112, a failure range analysis control unit 113, and a management information update unit 116 run. The CPU 121 executes corresponding programs to implement these functions.

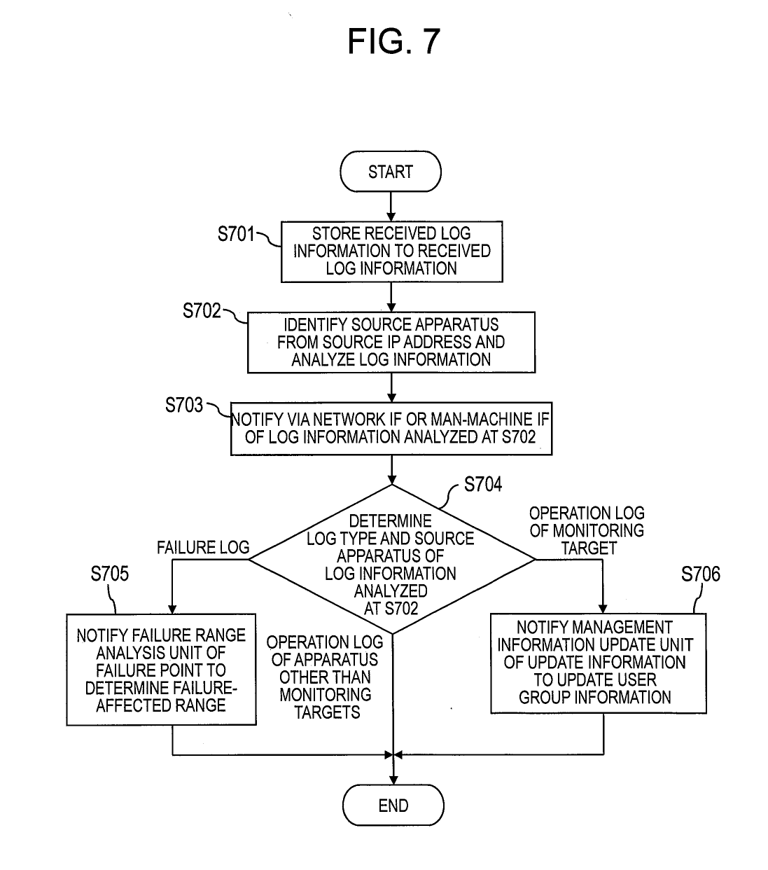

The received information analysis unit 112 analyzes data such as log information received from an external of the management apparatus 100 and forwards the received data to the failure range analysis control unit 113 or the management information update unit 116 depending on the analysis result. The processing of the received information analysis unit 112 will be described in detail with FIG. 7.

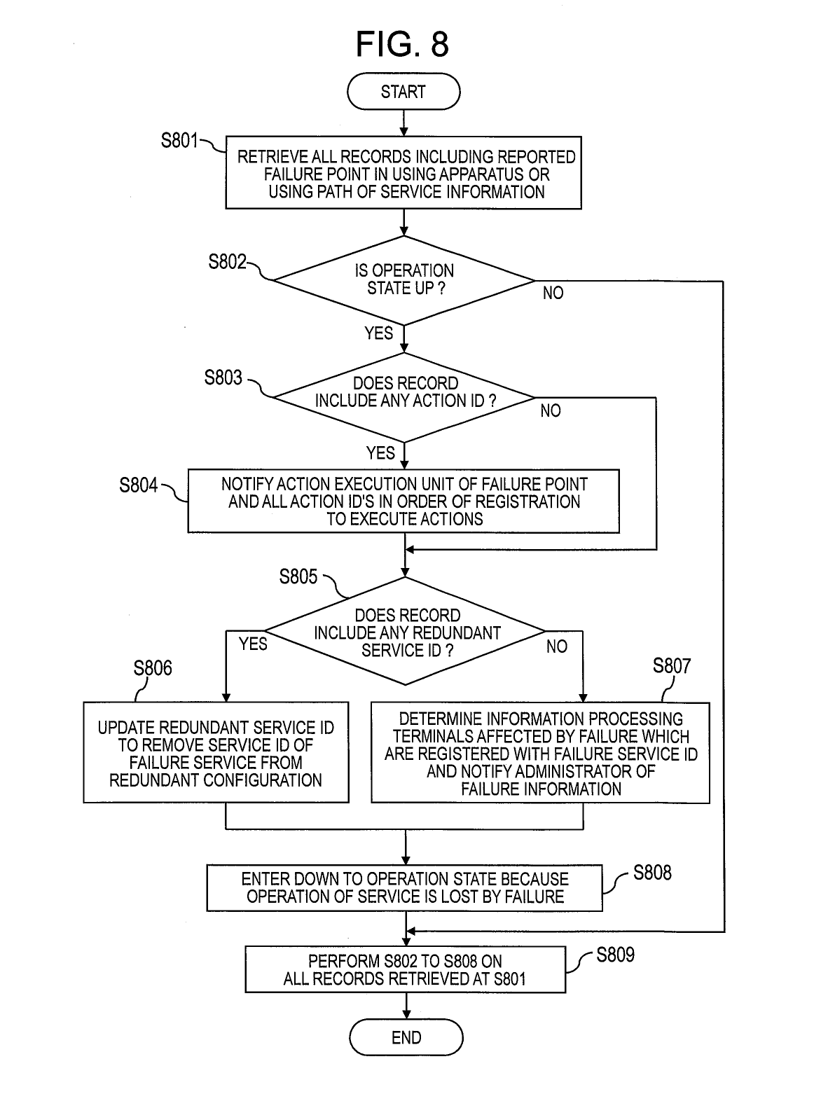

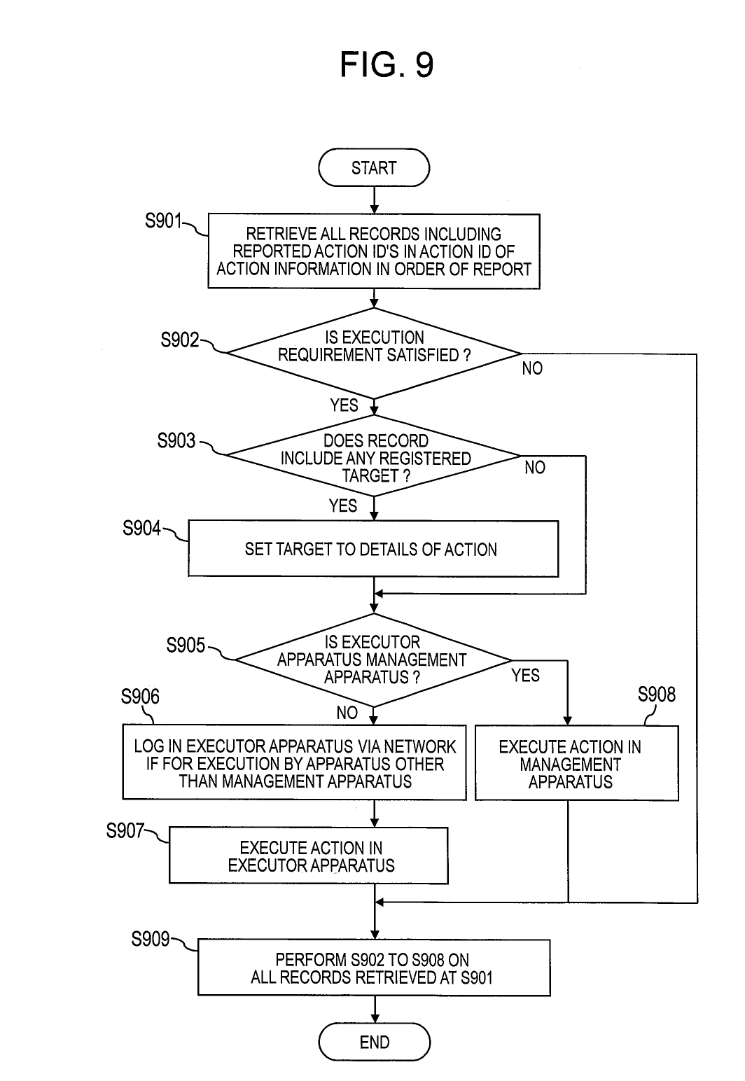

The failure range analysis control unit 113 determines, upon detection of a failure in the managed network 200, a failure range for the terminals, takes an action for the failure, and notifies the administrator of the determined failure range. The failure range analysis control unit 113 includes a failure range analysis unit 114 and an action execution unit 115. The failure range analysis unit 114 determines, upon detection of a failure in the managed network 200, the failure range for the terminals and notifies the administrator of the failure range. The action execution unit 115 takes an action for the failure. The processing of the failure range analysis unit 114 will be described in detail with FIG. 8 and the processing of the action execution unit 115 will be described in detail with FIG. 9.

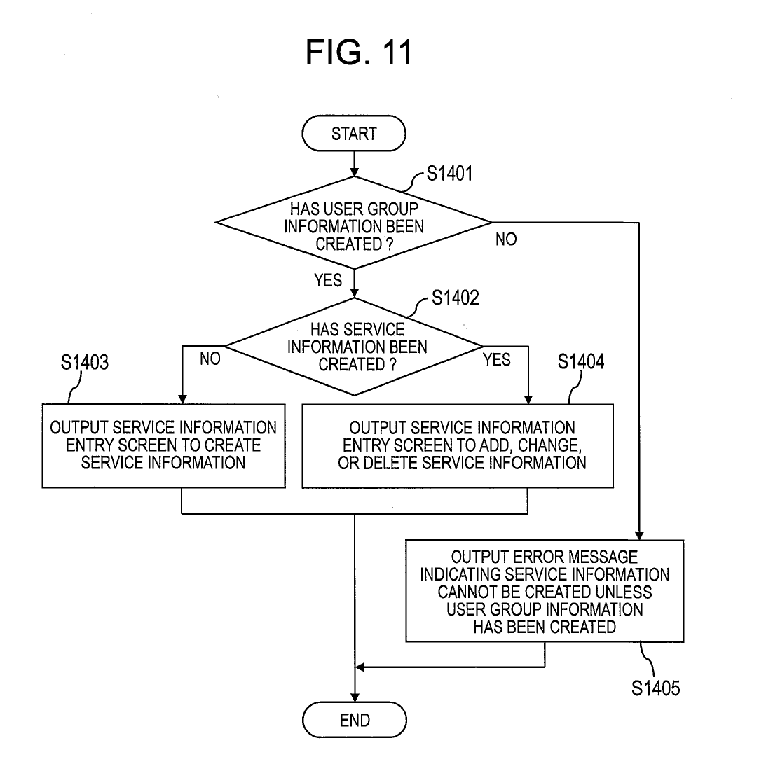

The management information update unit 116 creates or updates management information 101 stored in the secondary storage device 123. The processing of the management information update unit 116 will be described in detail with FIGS. 10 and 11.

The secondary storage device 123 stores management information 101 to determine the operation of the management apparatus 100. The management information 101 includes failure range analysis information 102 and network management information 107.

The failure range analysis information 102 is information required to analyze effects of failure on the terminals, information about processing to be performed when a failure is detected, and other information. The network management information 107 is information required to manage the managed network 200, formats to analyze log information, and other information.

The failure range analysis information 102 is explained. The failure range analysis information 102 includes user group information 103, action information 104, service information 105, and configuration information 106.

The user group information 103 is information to group and manage the terminals depending on their use conditions of the services provided by the service providing resources. The user group information 103 will be described in detail with FIG. 4.

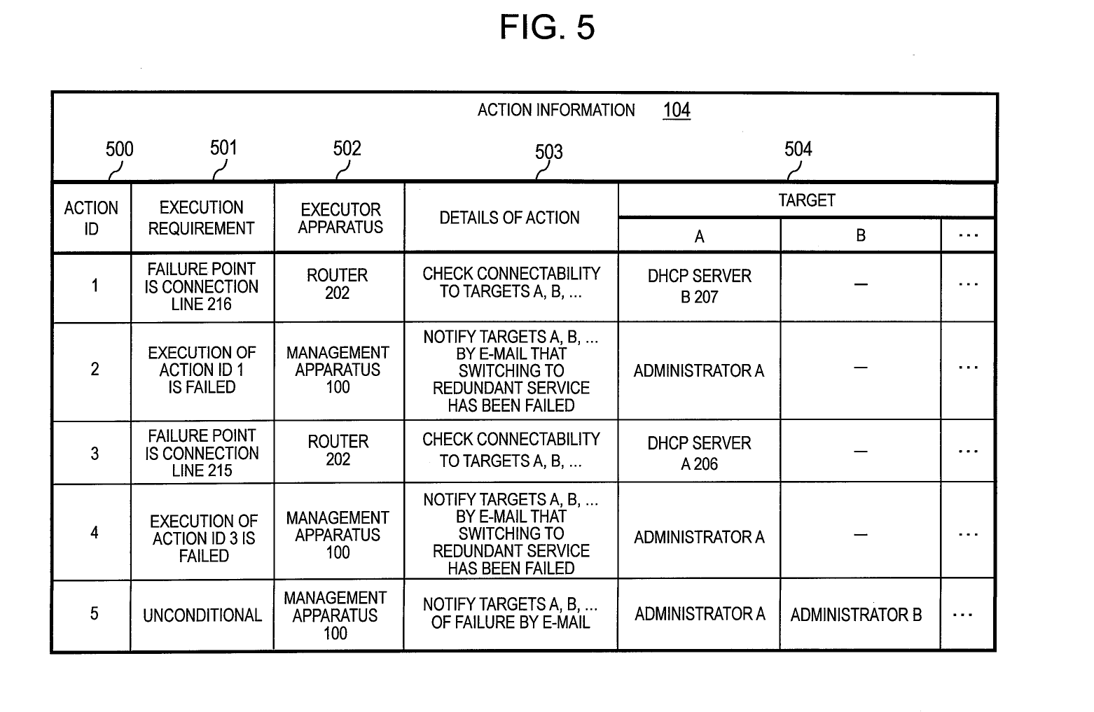

The action information 104 is information about actions to be taken in response to a failure, such as configuration change in an apparatus, and information about failure notification in response to a failure. The action information 104 will be described in detail with FIG. 5.

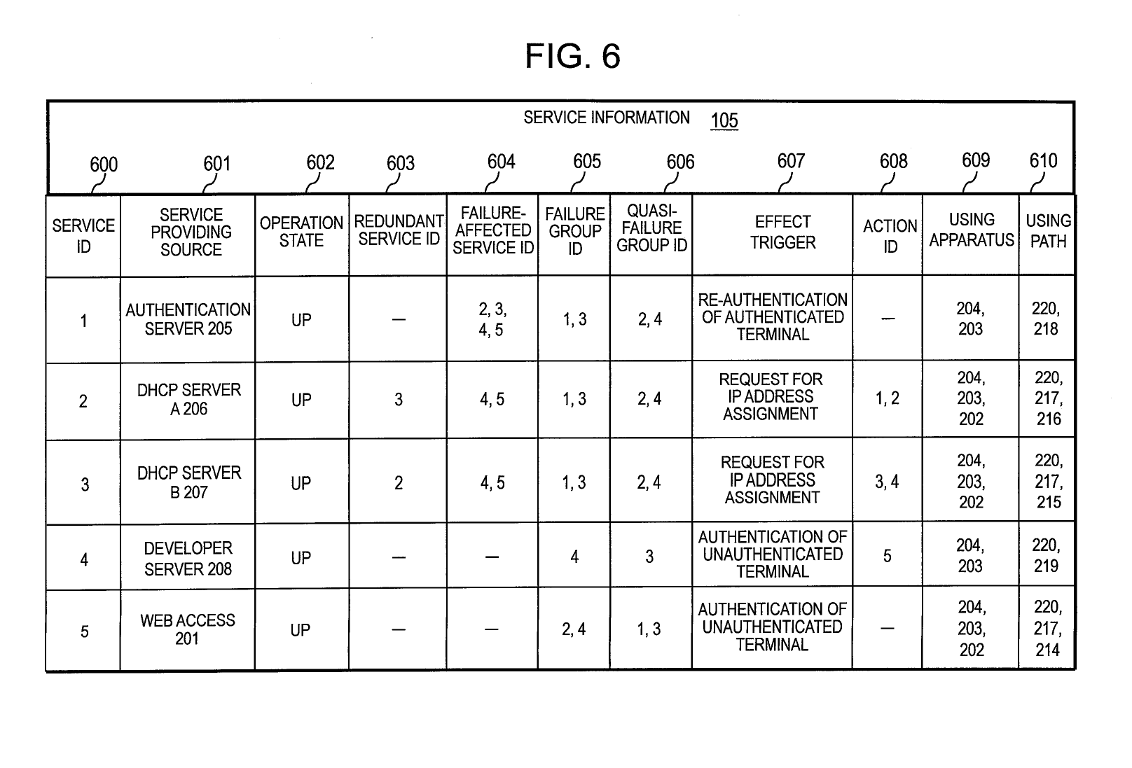

The service information 105 is information to associate each service provided by a service providing resource with paths and apparatuses through which data passes for terminals to use the service and a group of terminals that will lose the service when a failure occurs in one of the paths and apparatuses. The service information 105 will be described in detail with FIG. 6.

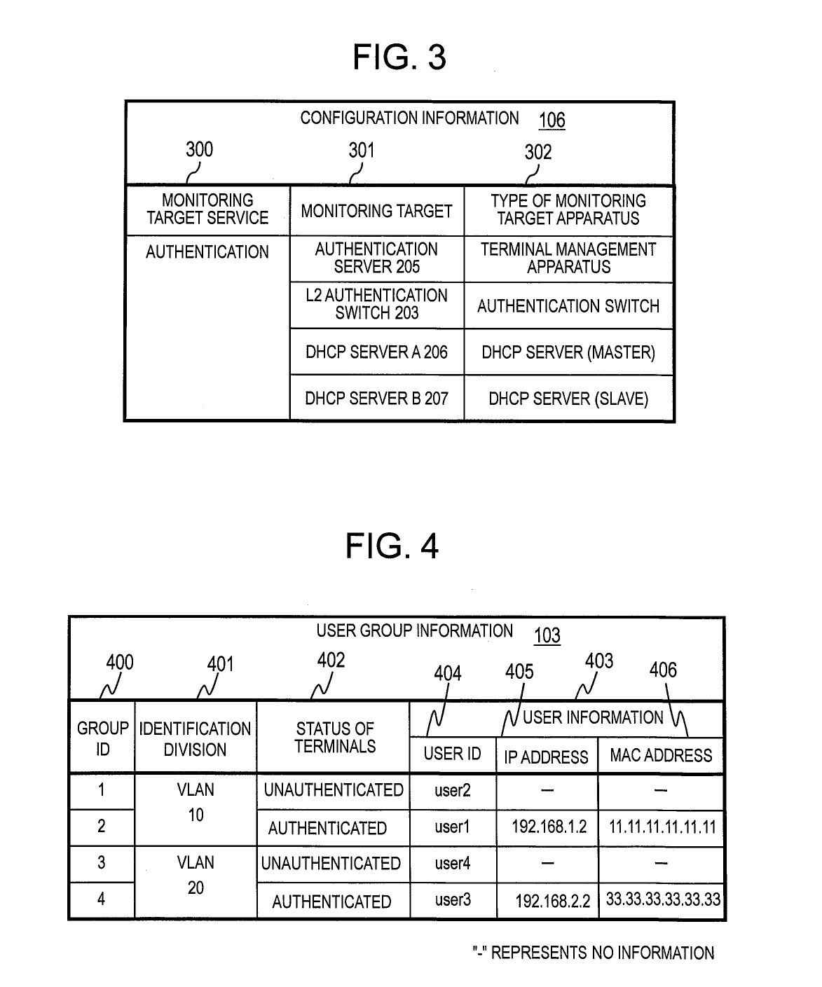

The configuration information 106 includes format information for the user group information 103, information for defining methods of updating the user group information 103, information specifying an apparatus or server to share the information on the terminals registered in the user group information 103, and information specifying where to acquire log information to be a trigger to change the user group information 103. The configuration information 106 will be described in detail with FIG. 3.

Now, the network management information 107 is explained. The network management information 107 includes apparatus information 108, management apparatus configuration information 109, network configuration information 110, and received log information 111.

The apparatus information 108 includes format information on log information depending on the vendor, the model name, and the software version of an apparatus or server that sends log information and information to identify whether the log information is failure log information or operation log information.

The management apparatus configuration information 109 is information designating where to output and how to output analyzed log information and where to notify of a failure.

The network configuration information 110 includes network topology information on the managed network 200 and information on vendors, model names and software versions of apparatuses or servers composing the network.

The received log information 111 is log information received by the management apparatus 100.

FIG. 3 is an explanatory diagram of the configuration information 106 in Embodiment 1 of this invention. The configuration information 106 includes a monitoring target service 300, monitoring targets 301, and types of monitoring target apparatuses 302.

A type of service to be monitored by the management apparatus 100 is registered in the monitoring target service 300. Depending on the type of service stored in the monitoring target service 300, the format of the user group information 103 is changed. The management apparatus 100 can monitor a different type of service by changing the type of service registered in the monitoring target service 300. The information to be stored in the monitoring targets 301 and the types of monitoring target apparatuses 302 depends on the type of service registered in the monitoring target service 300. In FIG. 3, the registered monitoring target service 300 is authentication.

A monitoring target 301 stores the identifier of an apparatus to register information on the terminals registered in the user group information 103 or the identifier of an apparatus to send log information to be a trigger for the management apparatus 100 to update the user group information 103. The management apparatus 100 updates the user group information 103 upon receipt of log information sent from the apparatus registered in the monitoring target 301. The monitoring target 301 may store a plurality of apparatuses.

A type of monitoring target apparatus 302 stores the type of the apparatus stored in the monitoring target 301.

FIG. 4 is an explanatory diagram of the user group information 103 in Embodiment 1 of this invention. The user group information 103 includes group IDs 400, identification divisions 401, statuses of terminals 402, and user information 403.

Each group ID 400 stores the identifier of a group. An identification division 401 and a status of terminals 402 store conditions for grouping terminals or the users of the terminals. The identification division 401 stores information of condition that does not change dynamically during operation unless the administrator changes it. In FIG. 4, the identification division 401 stores the identifier of a VLAN to which terminals belong after authentication by the authentication server 205. The status of terminals 402 stores information of condition that dynamically changes. In FIG. 4, the status of terminals stores “unauthenticated” indicating the condition that the terminals have not been authenticated by the authentication server 205 or “authenticated” indicating the condition that the terminals have been authenticated by the authentication server 205.

The user group information 103 shown in FIG. 4 defines four groups: Group 1 for which the identification division 401 is VLAN 10 and the status of terminals 402 is unauthenticated, Group 2 for which the identification division 401 is VLAN 10 and the status of terminals 402 is authenticated, Group 3 for which the identification division 401 is VLAN 20 and the status of terminals 402 is unauthenticated, and Group 4 for which the identification division 401 is VLAN 20 and the status of terminals 402 is authenticated.

The identification division 401 and the status of terminals 402 store conditions suitable for the type of service registered in the monitoring target service 300 in the configuration information 106.

User information 403 stores information on each terminal belonging to the group by satisfying the conditions stored in the identification division 401 and the status of terminals 402. Specifically, the user information 403 includes user IDs 404, IP addresses 405, and MAC addresses 406. The columns included in the user information 403 depend on the type of service stored in the monitoring target service 300 in the configuration information 106.

Each user ID 404 is information to be used when the authentication server authenticates the terminal and stores an identifier unique to the user of the terminal. The registration, change, or deletion of a user identifier in the authentication server 205 is performed by the management apparatus 100 to be so that the user identifiers in the user ID 404 are synchronized with the user identifier in the authentication server 205.

An IP address 405 stores the IP address assigned to the terminal. The management apparatus 100 can acquire the IP address from log information indicating assignment of an IP address to the terminal sent by the DHCP server.

A MAC address 406 stores the MAC address of the terminal. The management apparatus 100 can acquire the MAC address from log information indicating a success in authentication sent from the L2 authentication switch 203.

FIG. 5 is an explanatory diagram of the action information 104 in Embodiment 1 of this invention. The action information 104 includes action IDs 500, execution requirements 501, executor apparatuses 502, details of actions 503, and targets 504.

Each action ID 500 stores the identifier of processing (an action) executed in response to a failure. In the action information 104, one record represents an action; accordingly, it can be said that the action IDs 500 store the identifiers of records of the action information 104.

An execution requirement 501 stores a requirement to execute the action stored in the details of action 503. An executor apparatus 502 stores the identifier of the apparatus to execute the action registered in the details of action 503. Details of action 503 stores an action to be executed in response to a failure. The details of action 503 in FIG. 5 stores processing of ascertaining a configuration change and notifying the administrator of a failure.

A target 504 stores at least one apparatus or administrator to which the action registered in the details of action 503 is applied. If a plurality of apparatuses exist to which the action registered in the details of action 503 is applied, the target 504 may store a plurality of apparatuses or administrators.

It should be noted that actions that may possibly be registered in the details of actions 503 can be prepared in the management apparatus 100 and the administrator may select one of them to register it in details of action 503. As a result, the administrator does not have to write the action to the details of action 503 and can easily configure the action information 104.

FIG. 6 is an explanatory diagram of service information 105 in Embodiment 1 of this invention. The service information 105 includes service IDs 600, service providing sources 601, operation states 602, redundant service IDs 603, failure-affected service IDs 604, failure group IDs 605, quasi-failure group IDs 606, effect triggers 607, action IDs 608, using apparatuses 609, and using paths 610.

Each service ID 600 stores the identifier of a service. Since one record in the service information 105 represents one service, it can be said that the service IDs 600 store the identifiers of records of the service information 105.

A service providing source 601 stores the identifier of the service providing resource that provides the service managed by the management apparatus 100.

An operation state 602 stores information indicating whether the service providing resource identified by the identifier stored in the service providing source 601 can currently provide the service. Specifically, if the service providing resource can provide the service, the operation state 602 stores UP; if cannot, it stores DOWN. It should be noted that, even if the service providing resource is operated redundantly, the operation state 602 stores UP when the service providing resource can provide the service.

If the service providing resource identified by the identifier registered in the service providing source 601 is operated redundantly with another service providing resource, a redundant service ID 603 stores the identifier of the other service providing resource. In the case of redundant operation with three or more service providing resources, the redundant service ID 603 may store the identifiers of a plurality of service providing resources.

A failure-affected service ID 604 stores the identifiers of services (failure-affected services) that will be unavailable when the service providing resource identified by the identifier registered in the service providing source 601 becomes unable to provide a service, because of the effect of the unavailable service. The failure-affected service is, for example, a service provided using the service the service providing resource becomes unable to provide because of a failure.

A failure group ID 605 stores the identifiers of the groups of the terminals that lose the service when a failure has occurred in the managed network 200 and the service providing resource registered in the service providing source 601 cannot provide the service. The identifiers of the groups registered in the failure group IDs 605 correspond to the identifiers of the groups registered in the group IDs 400 in the user group information 103.

A quasi-failure group ID 606 stores the identifiers of the groups of the terminals that are not affected by the failure in the managed network 200 but lose the service that cannot be provided by the service providing resource registered in the service providing source 601 if the condition registered in the effect trigger 607 is satisfied. The identifiers of the groups stored in the quasi-failure group IDs 606 also correspond to the identifiers of the groups stored in the group IDs 400 in the user group information 103.

An effect trigger 607 stores a condition for the group identified by the group identifier registered in the quasi-failure group ID 606 to lose the service that cannot be provided by the service providing resource registered in the service providing source 601.

An action ID 608 stores the identifiers of processing to be performed in response to a failure in the managed network 200 in the sequence of execution. The identifiers stored in the action IDs 608 correspond to the identifiers registered in the action IDs 500 in the action information 104.

A using apparatus 609 stores the identifiers of apparatuses which pass data for the terminals to use the service. A using path 610 stores the identifiers of paths which pass data for the terminals to use the service.

In the service information 105 shown in FIG. 6, the identifiers of the apparatuses and paths which pass data for the terminals to use the service are separately stored in the using apparatus 609 and the using path 610; however, they do not need to be separated into the apparatuses and paths to be stored. For example, if a using path 610 stores the identifiers of the apparatuses which pass data for the terminals to use the service, the column of using apparatus 609 is unnecessary.

FIG. 7 is a flowchart of processing of the received information analysis unit 112 in Embodiment 1 of this invention.

The processing of the received information analysis unit 112 is executed by the CPU 121 upon receipt of log information via the network IF 117 from the external of the management apparatus 100.

First, the received information analysis unit 112 stores received log information to the received log information 111 (S701).

Next, the received information analysis unit 112 refers to the network configuration information 110 to identify the apparatus corresponding to the source IP address included in the received log information as the source apparatus. Then, the received information analysis unit 112 refers to the apparatus information 108 to analyze the received log information using the format information for the log information suitable for the vender, type, and software version of the identified source apparatus (S702).

Next, the received information analysis unit 112 outputs the log information analyzed at S702 to the destination designated in the management apparatus configuration information 109 via the network IF 117 or the man-machine IF 118 in accordance with the output method designated in the management apparatus configuration information 109 (S703). Through this step, the received information analysis unit 112 can inform the administrator of the received log information.

Next, the received information analysis unit 112 determines whether the type of the log information analyzed at S702 is failure log information or operation log information and further determines whether the source apparatus of the log information analyzed at S702 is an apparatus registered in the monitoring target 301 of the configuration information 106 (S704).

If the determination at S704 is that the type of the log information analyzed at S702 is failure log information, the received information analysis unit 112 locates the apparatus or path where a failure has occurred (failure point) from the log information analyzed at S702 and notifies the failure range analysis control unit 113 of the located failure point to determine the failure-affected range (S705) and terminates the processing.

If the determination at S704 is that the log information analyzed at S702 is operation log information and the source apparatus is an apparatus registered in the monitoring target 301 of the configuration information 106, the received information analysis unit 112 notifies the management information update unit 116 of update information to update the user group information 103 based on this log information (S706) and terminates the processing. The update information includes the type of the apparatus stored in the type of monitoring target apparatus 302 in the configuration information 106 corresponding to the source apparatus and information stored in the identification division 401, the status of terminals 402, and the user information 403 in the user group information 103 about the terminals on which the source apparatus executed the processing indicated in the operation log information.

If the determination at S704 is that the log information analyzed at S702 is operation log information and the source apparatus is not an apparatus registered in the monitoring target 301 of the configuration information 106, the received information analysis unit 112 terminates the processing.

Through the above-described processing, the received information analysis unit 112 analyzes received log information and notifies the failure range analysis control unit 113 or the management information update unit 116 of the failure point or update information based on the type of the received log information.

FIG. 8 is a flowchart of processing of the failure range analysis unit 114 in Embodiment 1 of this invention.

The processing of the failure range analysis unit 114 is executed by the CPU 121 when the failure range analysis control unit 113 is notified of the failure point at Step S705.

First, the failure range analysis unit 114 refers to the service information 105 to retrieve all the records including the identifier of the reported failure point in the using apparatus 609 or the using path 610 to determine the service providing resources affected by the failure (S801). The services represented by the records retrieved at S801 are the services affected by the failure point and are regarded as failure services.

If some records are retrieved at S801, the failure range analysis unit 114 sequentially selects the retrieved records one by one in the ascending order of the identifiers registered in the service ID 600 and repetitively performs the following processing until all the retrieved records are processed.

First, the failure range analysis unit 114 determines whether the record being processed holds UP in the operation state 602 to determine whether the service providing resource identified by the identifier registered in the service providing source 601 of the record can provide the service (S802).

If the determination at S802 is that the record holds UP in the operation state 602, in another word, if the service providing resource identified by the identifier registered in the service providing source 601 of the record can provide the service, the failure range analysis unit 114 determines whether the record includes any identifier registered in the action ID 608 of the record (S803).

If the determination at S803 is that the record being processed includes some identifiers in the action ID 608, the failure range analysis unit 114 notifies the action execution unit 115 of the failure point and the identifiers stored in the action ID 608 in the order of registration for the action execution unit 115 to perform the processing identified by the identifiers (S804), and proceeds to S805.

If the determination at S803 is that the record being processed does not include any identifier in the action ID 608, the failure range analysis unit 114 skips S804 and proceeds to S805.

Next, the failure range analysis unit 114 determines where the record being processed includes any identifier in the redundant service ID 603 to determine whether the service providing resource providing the failure service is operated redundantly with another service providing resource (S805).

If the determination at S805 is that the record being processed includes some identifier in the redundant service ID 603, or if the service providing resource providing the failure service is operated redundantly with another service providing resource, the other service providing resource is switched to the master apparatus; accordingly, there is no effect of the failure on terminals. For this reason, the failure range analysis unit 114 does not notify the administrator of the failure-affected range. Meanwhile, in order to remove the service providing resource providing the service of the record being processed from the redundant configuration of the other service providing resource, the failure range analysis unit 114 identifies the record which includes the identifier registered in the redundant service ID 603 of the record being processed in the service ID 600, deletes the identifier of the service registered in the service ID 600 of the record being processed from the identifiers registered in the redundant service ID 603 of the identified record (S806), and proceeds to Step S5808.

If the determination at S805 is that the record being processed does not include any identifier in the redundant service ID 603, or if the service providing resource providing the failure service is not operated redundantly with another service providing resource, the failure affects terminals. Accordingly, the failure range analysis unit 114 acquires information about the failure-affected range from the service information 105 and the user group information 103 and notifies the administrator of the acquired information about the failure-affected range (S807).

The acquiring information about the failure-affected range is specifically described.

In this embodiment, the information about the failure-affected range includes information on failure terminals, information on quasi-failure terminals, and information on failure-affected services.

The failure terminals are the terminals belonging to the group that will lose the failure service and the quasi-failure terminals are the terminals belonging to the group that does not lose the failure service but will lose the failure service if some requirement is satisfied. The failure-affected service is a service affected by the failure service.

The method of acquiring information on failure terminals is described. The failure range analysis unit 114 retrieves the identifiers registered in the failure group ID 605 of the record being processed and acquires, from the user group information 103, the information registered in the user information 403 of the records including the same identifiers as the retrieved identifiers in the group ID 400 for the information on failure terminals. The information on failure terminals may include the identifier of the failure service.

Next, the method of acquiring information on quasi-failure terminals is described. The failure range analysis unit 114 retrieves the identifiers registered in the quasi-failure group ID 606 and the requirements registered in the effect trigger 607 of the record being processed and acquires, from the user group information 103, the information registered in the user information 403 of the records having the same identifiers as the retrieved identifiers in the group ID 400 and the retrieved requirements registered in the effect trigger 607 as the information on quasi-failure terminals. The information on quasi-failure terminals may include the identifier of the failure service.

Next, the method of acquiring information on failure-affected services is described. The failure range analysis unit 114 retrieves the identifiers registered in the failure-affected service ID 604 of the record being processed and retrieves, from the records including the retrieved identifiers in the service ID 600, the identifiers registered in the service providing source 601 to acquire the retrieved identifiers registered in the failure-affected service ID 604 and the retrieved identifiers registered in the retrieved service providing source 601 as the information on failure-affected services.

After performing S806 or S807, the failure range analysis unit 114 enters DOWN in the operation state 602 of the record being processed (S808) since the service providing resource has been unable to provide the service because of the failure.

If determination at S802 is that the operation state 602 of the record holds DOWN, or when S808 has been performed, the failure range analysis unit 114 performs S802 to S808 for all the records retrieved at S801 (S809), and terminates the processing.

Through the above-described processing, the failure range analysis unit 114 notifies the administrator of information about failure terminals. Accordingly, the administrator can grasp the terminals that will lose the service as soon as a failure occurs. Furthermore, since the failure range analysis unit 114 notifies the administrator of information about quasi-failure terminals, the administrator can grasp the terminals that will lose the service if predetermined requirements are satisfied after occurrence of a failure. Since the failure range analysis unit 114 notifies the administrator of information about failure-affected services, the administrator can grasp the services that are affected by the service unavailable because of a failure.

FIG. 9 is a flowchart of processing of the action execution unit 115 in Embodiment 1 of this invention.

The processing of the action execution unit 115 is executed by the CPU 121 when the action execution unit 115 is notified of a failure point and the identifiers (action IDs) registered in the action ID 608 at S804.

First, the action execution unit 115 refers to the action information 104 to retrieve all the records including the reported action IDs in the action ID 500 (S901). At S901, the action execution unit 115 retrieves the records from the action information 104 one by one in the order of registration in the action ID 608 of the service information 105.

After retrieval of some records at S901, the action execution unit 115 sequentially selects the records to be processed one by one in the order of registration in the ID 608 of the service information 105 and repetitively performs the following processing until all the retrieved records are processed.

The action execution unit 115 determines whether the current condition satisfies the requirement registered in the execution requirement 501 of the record being processed (S902).

If the determination at S902 is that the current condition satisfies the requirement registered in the execution requirement 501 of the record being processed, the action execution unit 115 determines whether any identifier is held in the target 504 of the record being processed to determine whether to register an apparatus to apply the action in the details of action 503 of the same record (S903).

If the determination at S903 is that some identifier is held in the target 504 of the record being processed, the action execution unit 115 sets the identifier registered in the target 504 to the details of action 503 (S904).

If the determination at S903 is that no identifier is held in the target 504 or after performing S904, the action execution unit 115 determines whether the identifier of the management apparatus 100 is held in the executor apparatus 502 of the record being processed to determine whether the apparatus to perform the processing registered in the details of action 503 of the record being processed is the management apparatus 100 (S905).

If the determination at S905 is that the identifier of the management apparatus 100 is not held in the executor apparatus 502 of the record being processed, the processing registered in the details of action 503 of the record is performed by an apparatus other than the management apparatus 100; accordingly, the action execution unit 115 logs in the apparatus other than the management apparatus 100 via the network IF 117 to remotely manipulate the apparatus other than the management apparatus 100 (S906).

Then, the action execution unit 115 performs the processing registered in the details of action 503 of the record being processed in the apparatus logged in at S906 (S907).

If the determination at S905 is that the identifier of the management apparatus 100 is included in the executor apparatus 502 of the record being processed, the action execution unit 115 performs the processing registered in the details of action 503 of the record in the management apparatus 100 (S908).

If the determination at S902 is that the current condition does not satisfy the requirement registered in the execution requirement 501 of the record being processed, or after performing S907 or S908, the action execution unit 115 performs S902 to S908 on all the records retrieved at S901 (S909), and terminates the processing.

Through the above-described processing, when a failure occurs, the management apparatus 100 can perform predetermined processing associated with the failure service. This approach can prevent secondary damage that the administrator mistakenly designates a wrong action when a failure actually has occurred so that the terminals not affected by the failure are wrongly reconfigured.

FIG. 10 is a flowchart of processing of the management information update unit 116 in Embodiment 1 of this invention.

The processing of the management information update unit 116 is executed by the CPU 121 when update information is input to the management information update unit 116 at S706 in FIG. 7 or when the administrator inputs a request to enter failure range analysis information 102 or entry data for the failure range analysis information 102 to the management information update unit 116 via the man-machine IF 118.

The request to enter failure range analysis information 102 is input to the management information update unit 116 when the man-machine IF 118 accepts the administrator's operation to enter failure range analysis information 102 and requests the management information update unit 116 to output an entry screen for the kind of failure range analysis information 102 the administrator wants to define via the man-machine IF 118.

First, the management information update unit 116 determines whether the source of the data input that triggered the processing of the management information update unit 116 is the man-machine IF 118 (S1001).

If the determination at S1001 is that the data input source is the man-machine IF 118, the data is either an entry request or entry data; accordingly, the management information update unit 116 determines whether the data is an entry request (S1002).

If the determination at S1002 is that the data is an entry request, the management information update unit 116 identifies the kind of the entry request (S1003). Specifically, there are four kinds of entry requests: configuration information entry request for requesting entry of configuration information 106, user group information entry request for requesting entry of user group information 103, action information entry request for requesting entry of action information 104, and service information entry request for requesting entry of service information 105.

If the determination at S1003 is that the kind of the entry request is the configuration information entry request, the management information update unit 116 outputs a configuration information entry screen via the man-machine IF 118 for the administrator to input entry data for the configuration information 106 (S1004) and terminates the processing. Specifically, the configuration information entry screen is a screen that allows the administrator to enter a monitoring target service 300 and a monitoring target 301 in the configuration information 106. The management information update unit 116 may acquire the configuration information 106 to show the current contents of the configuration information 106 in the configuration information entry screen. The configuration information entry screen may include a message to urge the administrator to enter configuration information 106.

If the determination at S1003 is that the kind of the entry request is the user group information request, the management information update unit 116 outputs a user group information entry screen via the man-machine IF 118 for the administrator to input entry data for the user group information 103 (S1005) and terminates the processing.

The processing at S1005 is explained specifically. First, the management information update unit 116 determines whether the user group information 103 has any record to determine whether the user group information 103 has already been created.

If the user group information 103 has no record, the management information update unit 116 determines that the user group information has not been created yet and outputs a user group information entry screen which allows the administrator to input entry data for the group ID 400, identification division 401, and user information 403 in a format created at S1009 via the man-machine IF 118 to create user group information 103.

If the user group information 103 has some record, the management information update unit 116 determines that the user group information 103 has already been created and outputs the user group information 103 as a user group information entry screen via the man-machine IF 118 to allow the administrator to input entry data for changing or deleting some user group information 103. This user group information entry screen includes the above-described screen for the administrator to create the user group information 103.

If the determination at S1003 is that the kind of the entry request is the action information entry request, the management information update unit 116 outputs an action information entry screen via the man-machine IF 118 for the administrator to input entry data for the action information 104 (S1006) and terminates the processing.

The processing at S1006 is explained specifically. First, the management information update unit 116 determines whether the action information 104 has any record to determine whether the action information 104 has already been created.

If the action information 104 has no record, the management information update unit 116 determines that the action information has not been created yet and outputs an action information entry screen which allows the administrator to input entry data for the action ID 500, execution requirement 501, executor apparatus 502, details of action 503, and target 504 via the man-machine IF 118 to create action information 104. The management information update unit 116 may output the network configuration information 110 via the man-machine IF 118 to allow the administrator to input the entry data for the executor apparatus 502 by selecting from the information registered in the network configuration information 110.

If the action information 104 has some record, the management information update unit 116 determines that the action information 104 has already been created and outputs the action information 104 as an action information entry screen via the man-machine IF 118 to allow the administrator to input entry data by changing or deleting some action information 104. This action information entry screen includes the above-described screen for the administrator to create the action information 104.

If the determination at S1003 is that kind of the entry request is the service information entry request, the management information update unit 116 outputs a service information entry screen via the man-machine IF 118 for the administrator to input entry data for the service information 105 (S 1007) and terminates the processing. The processing at S1007 is described with FIG. 11.

FIG. 11 is a flowchart of outputting a service information entry screen in Embodiment 1 of this invention.

Since the identifiers in the group ID 400 in the user group information 103 are registered in the failure group ID 605 and the quasi-failure group ID 606 in the service information 105, entry of service information 105 requires that the user group information 103 has been created. For this reason, the management information update unit 116 determines whether the user group information 103 has any record to determine whether the user group information 103 has been created (S1401).

If the determination at S1401 is that the user group information 103 has some record, the management information update unit 116 determines that the user group information 103 has been created and further determines whether the service information 105 has any record to determine whether the service information 105 has been created (S1402).

If the determination at S1402 is that the service information 105 has no record, the management information update unit 116 determines that the service information 105 has not been created yet, outputs a service information entry screen which allows the administrator to input entry data for the service ID 600, service providing source 601, operation state 602, redundant service ID 603, failure-affected service ID 604, failure group ID 605, quasi-failure group ID 606, effect trigger 607, action ID 608, using apparatus 609, and using path 610 to create the service information 105 via the man-machine IF 118 (S1403), and terminates the processing.

The management information update unit 116 may include the user group information 103 in the service information entry screen to allow the administrator to input entry data for the failure group ID 605 and the quasi-failure group ID 606 by selecting from the identifiers registered in the group ID 400 in the user group information 103.

The management information update unit 116 may also include the action information 104 in the service information entry screen to allow the administrator to input entry data for the action ID 608 by selecting from the identifiers registered in the action ID 500 in the action information 104.

The management information update unit 116 may also include the network configuration information 110 in the service information entry screen to allow the administrator to input entry data for the using apparatus 609 and using path 610 by selecting from the network configuration information 110.

If the determination at S1402 is that the service information 105 has some record, the management information update unit 116 determines that the service information 105 has already been created and outputs the service information 105 as a service information entry screen via the man-machine IF 118 to allow the administrator to input entry data for changing or deleting some service information 105 (S1404), and terminates the processing. This service information entry screen includes the screen for the administrator to create the service information 105 described at S1403.

If the determination at S1401 is that the user group information 103 has no record, the user group information 103 has not been created yet; accordingly, the management information update unit 116 outputs an error message screen indicating that the service information 105 cannot be created via the man-machine IF 118 (S1405) and terminates the processing.

Returning to FIG. 10, described is the case where the determination at S1002 is that the data input by the management information update unit 116 is not an entry request but entry data. In this case, the management information update unit 116 determines the kind of entry data (S1008). Specifically, there are four kinds of entry data: configuration information entry data of entry data for the configuration information 106, user group information entry data of entry data for the user group information 103, action information entry data of entry data for the action information 104, and service information entry data of entry data for the service information 105.

If the determination at S1008 is that the kind of entry data is configuration information entry data, the management information update unit 116 executes entry of the configuration information 106 based on the received configuration information entry data (S 1009) and terminates the processing.

The processing on configuration information is specifically explained. The management information update unit 116 registers the configuration information entry data in the configuration information 106 and creates a format of the user group information 103 based on the kind of service registered in the monitoring target service 300 in the configuration information 106. This is because different formats are used for the user group information 103 depending on the service to be monitored.

If the determination at S1008 is that the kind of entry data is user group information entry data, the management information update unit 116 executes entry of the user group information 103 based on the received user group information entry data (S 1010) and terminates the processing.

The entry of user group information 103 is specifically explained. The management information update unit 116 registers the received user group information entry data in the user group information 103. The user group information entry data includes a user ID, a password, and an identification division. The management information update unit 116 refers to the configuration information 106 to acquire the identifier registered in the monitoring target 301 of the record holding “terminal management apparatus” in the type of monitoring target apparatus 302 and logs in the apparatus (the authentication server 205 in FIG. 3) with the identifier via the network IF 117. Then, the management information update unit 116 registers the identification division 401 and the user information 403 of the received user group information entry data in the apparatus logged in. In this embodiment, the authentication server 205 does not register, change, or delete information relating to terminal authentication (a user ID, a password, and an identification division) based on the information received from an apparatus other than the management apparatus 100. In other words, the authentication server 205 registers, changes, or deletes information relating to authentication based on only the information received from the management apparatus 100. Accordingly, the information relating to authentication can be synchronized between the authentication server 205 and the management apparatus 100.

If the determination at S1008 is that the kind of entry data is action information entry data, the management information update unit 116 executes entry of the action information 104 based on the received action information entry data (S1011) and terminates the processing. In entering action information 104, the management information update unit 116 registers the received action information entry data in the action information 104.

If the determination at S1008 is that the kind of entry data is service information entry data, the management information update unit 116 executes entry of the service information 105 based on the received service information entry data (S1012) and terminates the processing. In entering service information 105, the management information update unit 116 registers the received service information entry data in the service information 105.

If the determination at S1001 is that the data input source is not the man-machine IF 118 or that the data input source is the received information analysis unit 112, the received data is update information. Accordingly, the management information update unit 116 identifies the type of the apparatus registered in the type of monitoring target apparatus 302 included in the update information and determines the update method suitable for the identified type of the apparatus (S1013).

The management information update unit 116 updates the identification division 401, status of terminals 402, and user information 403 in the user group information 103 based on the received update information by the determined update method (S1014).

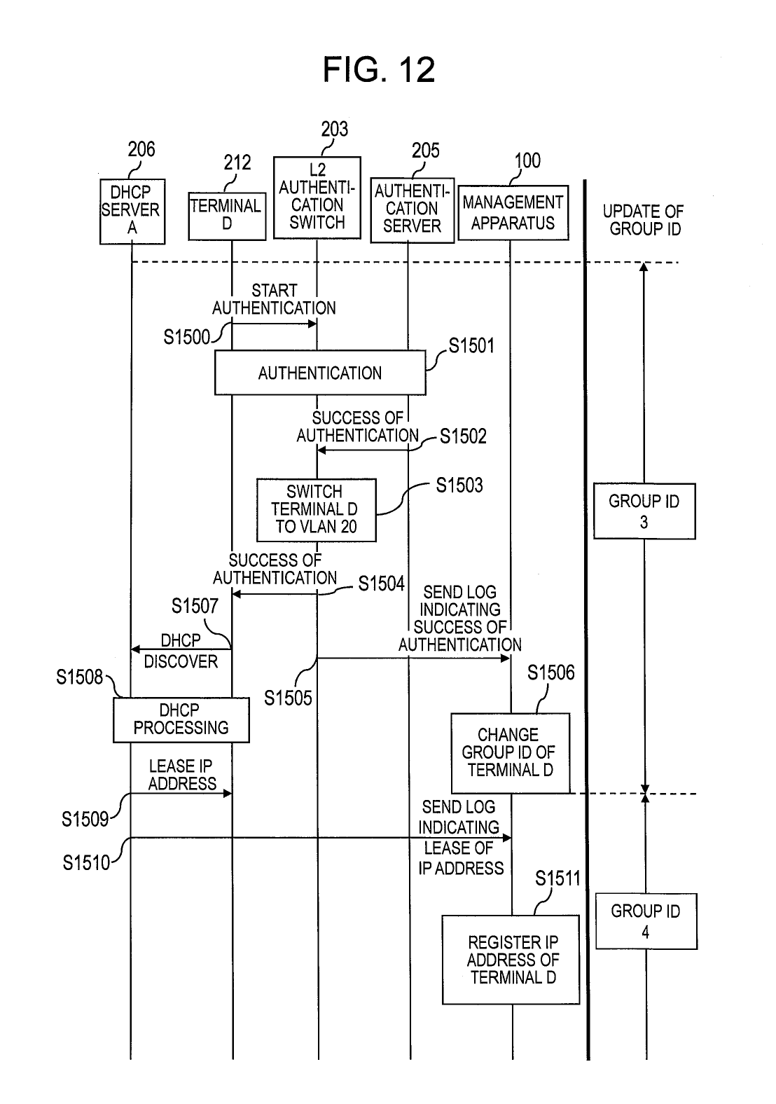

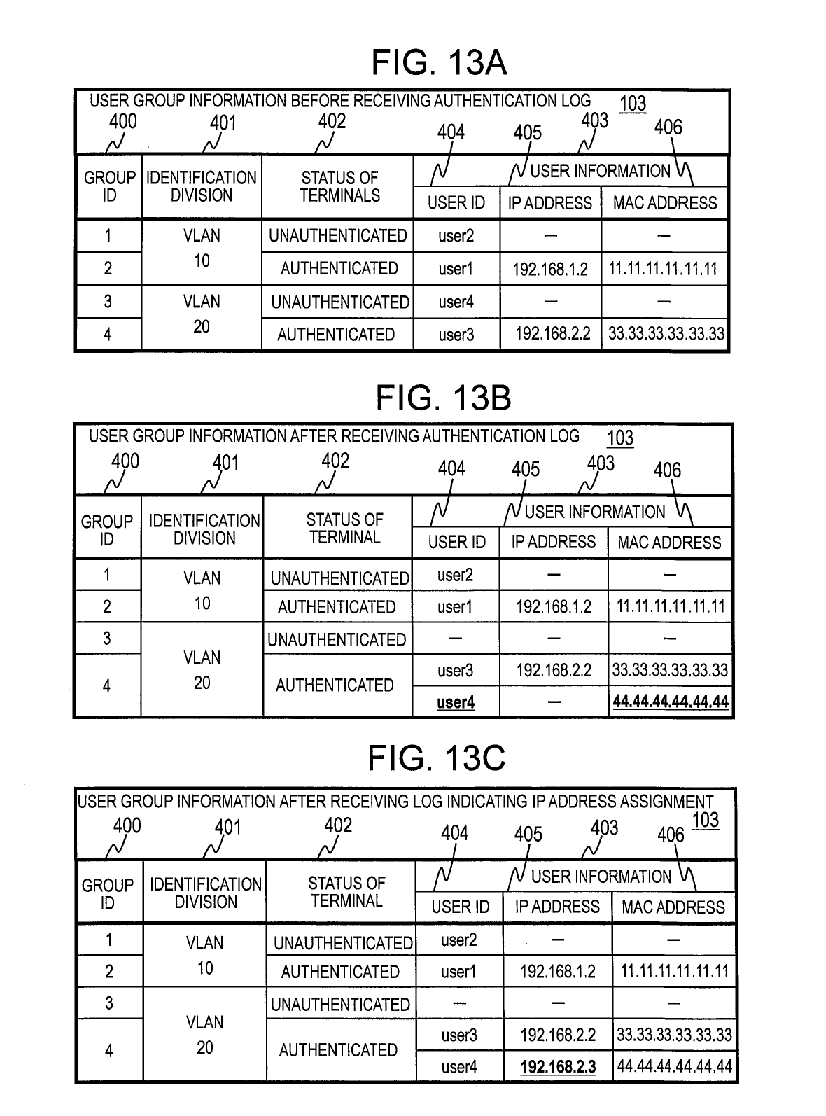

Next, described with FIGS. 12 to 13C as well as FIG. 1 are operations when the management apparatus 100 receives log information indicating that the terminal D 212 has been authenticated from the L2 authentication switch 203 and when the management apparatus 100 receives log information indicating that the terminal D212 has been assigned an IP address from the DHCP server A 206.

FIG. 12 is a sequence diagram of authentication of the terminal D 212 and assignment of an IP address to the terminal D 212 in Embodiment 1 of this invention.

When the terminal D 212 sends an authentication packet including a user ID, a password, and a MAC address of the terminal D 212 to the L2 authentication switch 203, the authentication is started (S1500).

The L2 authentication switch 203 sends the received authentication packet to the authentication server 205 and thereafter, the L2 authentication switch 203 relays authentication-related packets communicated between the terminal D 212 and the authentication server 205 to perform the authentication (S1501).

When the authentication is completed successfully at S1501 or when the user ID and password sent from the terminal D 212 match the user ID and password held in the authentication server 205, the authentication server 205 notifies the L2 authentication switch 203 of the success of the authentication (S1502).

When notified of the success of the authentication, the L2 authentication switch 203 switches the VLAN for the terminal D 212 from the VLAN 1 for unauthenticated terminals to the VLAN 20 the authenticated terminal D212 should belong to (S1503). Then, the L2 authentication switch 203 notifies the terminal D 212 of the success of the authentication (S 1504).

The L2 authentication switch 203 also sends log information indicating the success of the authentication of the terminal D 212 to the management apparatus 100 (S1505).

Upon receipt of the log information sent from the L2 authentication switch 203, the management apparatus 100 analyzes the received log information and changes the group ID 400 in the user group information 103 from 3 to 4 so that the terminal D 212 which has belonged to the group 3 will belong to the group 4 (S1506). At S1506, the management apparatus 100 registers the MAC address included in the received log information in the MAC address 406 of the user group information 103 on the terminal D 212.

When the terminal D 212 is notified of the success of the authentication from the L2 authentication switch 203 at S1504, it sends a DHCP DISCOVER, which is a request for IP address assignment, to the DHCP server A 206 since the network connected from the terminal D 212 is changed to the VLAN 20 (S1507). Thereafter, DHCP processing is executed between the DHCP server A 206 and the terminal D 212 (S1508).

When the DHCP processing is completed successfully, the DHCP server A 206 assigns an IP address to the terminal D 212 (S 1509). The DHCP server A 206 sends the management apparatus 100 log information indicating that the DHCP server A 206 assigned the terminal D 212 an IP address (S1510). This log information includes the MAC address of the terminal D 212 and the IP address assigned to the terminal D 212.

Upon receipt of the log information indicating the assignment of an IP address from the DHCP server A 206, the management apparatus 100 analyzes the received log information and registers the IP address included in the received log information in the IP address 405 of the user group information 103 on the terminal D 212 (S1511).

Next, S1506 and S1511 in FIG. 12 are described in detail with FIGS. 13A to 13C.

FIG. 13A is an explanatory diagram of the user group information 103 before the authentication by the authentication server 205 in Embodiment 1 of this invention. FIG. 13B is an explanatory diagram of the user group information 103 after the authentication by the authentication server 205 but before the assignment of an IP address to the terminal D 212. FIG. 13C is an explanatory diagram of the user group information 103 after the assignment of an IP address to the terminal D 212.

According to the user group information 103 shown in FIG. 13A before execution of S1506 in FIG. 12, the terminal D 212 belongs to the group 3, since the terminal D 212 has not been authenticated.

The processing at S1506 is explained. When the management apparatus 100 receives log information via the network IF 117, the processing of the received information analysis unit 112 shown in FIG. 7 is performed.

Starting from S701, the management apparatus 100 stores the received log information in the received log information 111. Next at S702, the management apparatus 100 refers to the network configuration information 110 to identify the apparatus corresponding to the source IP address included in the received log information as the L2 authentication switch 203 and analyzes the received log information using the format information for the log information of the L2 authentication switch 203. Then, at S703, the management apparatus 100 notifies the administrator of the log information analyzed at S702 by the method defined in the management apparatus configuration information 109 via the network IF 117 or the man-machine IF 118.

At S704, since the type of the log information analyzed at S702 is operation log information and the apparatus corresponding to the source IP address (L2 authentication switch 203) is an apparatus registered in the monitoring target 301 of the configuration information 106, the management apparatus 100 proceeds to perform S706.

At S706, the management apparatus 100 notifies the management information update unit 116 of update information to update the user group information 103. The update information includes the type of apparatus of the transmission source apparatus (authentication switch) registered in the type of monitoring target apparatus 302 of the configuration information 106 and the identification division 401 (VLAN 20), status of terminals 402 (authenticated), and information to be registered in user information 403 (user4, and “44.44.44.44.44.44”) in the user group information 103 on the terminal on which the transmission source terminal performed processing related to the operation log information.

When the management information update unit 116 is informed of the update information, the management apparatus 100 executes the management information update unit 116 shown in FIG. 10.

Starting from S1001, the management apparatus 100 proceeds to perform the processing at S1013 since the source of data input that triggered the processing of the management information update unit 116 is not the man-machine IF 118 but the received information analysis unit 112.

At S1013, since the type of the apparatus registered in the type of monitoring target apparatus 302 in the configuration information 106 included in the update information is authentication switch, the management apparatus 100 determines to update the user group information 103 based on the log information sent from the authentication switch, and identifies the update method suitable for the authentication switch.

At S1014, the management apparatus 100 searches the group IDs 400 in the user group information 103 for a record including user4 included in the update information and deletes the record. The management apparatus 100 adds a record to the group (group ID 4) for which the identification division 401 is VLAN 20 included in the update information and the status of terminals 402 indicates authenticated. The management apparatus 100 registers user4 included in the update information in the user ID 404 of the added record and registers “44.44.44.44.44.44” included in the update information in the MAC address 406 of the same record in the user information 403. Through this operation, the user group information 103 shown in FIG. 13A is updated into the user group information 103 shown in FIG. 13B.

Next, the processing at S1511 is explained. When the management apparatus 100 receives log information from the DHCP server A 206, the processing of the received information analysis unit 112 shown in FIG. 7 is performed.

Since the processing of S701 to S703 is the same as the above-described processing at S1506, the explanation thereof is omitted.

At S704, since the type of log information analyzed at S702 is operation log information and the apparatus corresponding to the source IP address (DHCP server A 206) is registered in the monitoring target 301 in the configuration information 106, the management apparatus 100 proceeds to perform S706.

At S706, the management apparatus 100 notifies the management information update unit 116 of the update information to update the user group information 103. The update information includes the type of apparatus of the transmission source apparatus (DHCP server) registered in the type of monitoring target apparatus 302 in the configuration information 106 and information to be registered in the user information 403 (the MAC address “44.44.44.44.44.44” and the IP address “192.168.2.3”) of the user group information 103 on the terminal on which the transmission source terminal performed processing related to the operation log information.

When the management information update unit 116 is informed of the update information, the management apparatus 100 executes the management information update unit 116 shown in FIG. 10.

At S1001, since the source of data input that triggered the processing of the management information update unit 116 is the received information analysis unit 112, the management apparatus 100 proceeds to perform S1013.

At S1013, since the type of apparatus registered in the type of monitoring target apparatus 302 of the configuration information 106 included in the update information is DHCP server, the management apparatus 100 determines to update the user group information 103 based on the log information from the DHCP server, and identifies the update method suitable for the DHCP server.

At S1014, the management apparatus 100 searches the MAC address 406 in the user group information 103 for the MAC address “44.44.44.44.44.44” included in the update information and registers the IP address “192.168.2.3” included in the update information in the IP address 405 of the retrieved record. Through this operation, the user group information 103 shown in FIG. 13B is updated into the user group information 103 shown in FIG. 13C.

Next described are processing of the management apparatus 100 in the event of a failure in the connection line 216 in FIG. 1 and processing of the management apparatus 100 in the event of a failure in the connection line 215 in FIG. 1 after occurrence of the failure in the connection line 216.

In this example, it is assumed that the management apparatus 100 has the configuration information 106 shown in FIG. 3, the user group information 103 shown in FIG. 4, the action information 104 shown in FIG. 5, and the service information 105 shown in FIG. 6. Furthermore, it is assumed that the user group information 103 is the state shown in FIG. 13C, which is the state after the terminal D 212 has been assigned an IP address. First, the processing of the management apparatus 100 in the event of a failure in the connection line 216 is described.

When the router 202 detects a failure in the connection line 216, it sends log information indicating the detection of failure to the management apparatus 100. The router 202 can detect a failure in the connection line 216 by electrical disconnection; however, even in the case of no electrical disconnection, it can detect a failure in the connection line 216 by sending a packet including a response request to the DHCP server A 206 and receiving no response from the DHCP server A 206 for a predetermined time.

Upon receipt of the log information from the router 202 via the network IF 117, the management apparatus 100 executes the received information analysis unit 112 shown in FIG. 7.

First at S701, the management apparatus 100 stores the received log information in the received log information 111. Next at S702, the management apparatus 100 identifies the apparatus corresponding to the source IP address included in the received log information as the router 202 and analyzes the received log information using the format information for the log information of the router 202. Then, at S703, the management apparatus 100 notifies the administrator of the log information analyzed at S702 by the method defined in the management apparatus configuration information 109 via the network IF 117 or the man-machine IF 118.

At S704, since the type of log information analyzed at S702 is failure log information, the management apparatus 100 proceeds to perform S705.

At S705, the management apparatus 100 notifies the failure range analysis unit 114 of the failure point (connection line 216) for analysis of failure range and terminates the processing.

When the failure range analysis unit 114 is notified of the failure point, the management apparatus 100 executes the failure range analysis unit 114 shown in FIG. 8.

At S801, the management apparatus 100 refers to the service information 105 and retrieves the record having the service ID 2 in which the identifier of the connection line 216 is held in the using path 610.

At S802, since the operation state 602 of the record of the service ID 2 holds UP, the management apparatus 100 proceeds to perform S803.

At S803, since the action ID 608 of the record having the service ID 2 holds identifiers, the management apparatus 100 proceeds to perform S804.

At S804, the management apparatus 101 notifies the action execution unit 115 of the action IDs 1 and 2 registered in the action ID 608 of the record having the service ID 2 in the order of registration.

At S805, since the redundant service ID 603 of the record of the service ID 2 holds an identifier, the management apparatus 100 proceeds to perform S806.

At S806, the management apparatus 100 deletes the service ID 2 registered in the redundant service ID 603 from the record of the service ID 3 which includes the service ID 2 in the redundant service ID 603.

At S808, since the service of the service ID 2 has been unavailable because of the failure in the connection line 216, the management apparatus 100 enters DOWN in the operation state of the record of the service ID 2.

At S809, since the processing of S802 to S808 has been performed on all the records retrieved at S801, the management apparatus 100 terminates the processing.

When the action execution unit 115 is notified of the action IDs 1 and 2, the management apparatus 100 executes the action execution unit 115 shown in FIG. 9.

First at S901, the management apparatus 100 refers to the action information 104 and retrieves the records containing the reported action IDs 1 and 2 in the action ID 500 in the order of report.

At S902, since the requirement “The failure point is the connection line 216” registered in the execution requirement 501 of the retrieved record of the action ID “1” is satisfied, the management apparatus 100 proceeds to perform S903.

At S903, since the target 504 of the record of the action ID 1 includes an identifier, the management apparatus 100 proceeds to perform S904.

At S904, the management apparatus 100 sets the DHCP server B 207 registered in the target 504 to the target of the action registered in the details of action 503 of the record of the action ID 1. This means that the target to check the connectability is determined to be the DHCP server B 207.

At S905, since the executor apparatus 502 of the record of the action ID 1 holds the router 202, the management apparatus 100 proceeds to perform S906. At S906, the management apparatus 100 logs in the router 202 via the network IF 117.

At S907, the management apparatus 100 makes the router 202 check connectability to the DHCP server B 207 and holds the result of the connectability check. In this embodiment, it is assumed that the management apparatus 100 succeeds in the connectability check.

At S909, the management apparatus 100 performs processing of S902 to S908 on the record having the action ID 2 retrieved at S901.

In this case, since the connectability check with the record having the action ID 1 has been completed successfully at S907, the requirement registered in the execution requirement 501 of the retrieved record of the action ID 2, “The execution of action ID 1 is failed” is not satisfied at S902, the management apparatus 100 skips S903 to S908 and proceeds to perform S909.

At S909, since the processing of S902 to S908 has been performed on all the records retrieved at S901, the management apparatus 100 terminates the processing of the action execution unit 115.

Next, described is the processing of the management apparatus 100 in the event of a failure in the connection line 215 after execution of the processing of management apparatus 100 in response to the failure in the connection line 216.

When the router 202 detects a failure in the connection line 215, it sends log information indicating the detection of failure to the management apparatus 100.

Upon receipt of the log information from the router 202, the management apparatus 100 performs received information analysis shown in FIG. 7. This received information analysis is the same as the received information analysis in the event of the failure in the connection line 216; accordingly, the explanation thereof is omitted.

When the failure range analysis unit 114 is notified of the failure point (connection line 215) at S705 in the received information analysis, the management apparatus 100 executes the failure range analysis unit 114 shown in FIG. 8.

At S801, the management apparatus 100 refers to the service information 105 and retrieves the record having the service ID 3 holding the identifier of the connection line 215 in the using path 610.

At S802, since the operation state 602 of the record of the service ID 3 holds UP, the management apparatus 100 proceeds to perform S803.

At S803, since the action ID 608 of the record of the service ID 3 holds identifiers, the management apparatus 100 proceeds to perform 5804.

At S804, the management apparatus 100 notifies the action execution unit 115 of the action IDs 3 and 4 registered in the action ID 608 of the record of the service ID 3 in the order of registration.

At S805, since the redundant service ID 603 of the record having the service ID 3 holds no identifier, the management apparatus 100 proceeds to perform S807.

At S807, the management apparatus 100 acquires group IDs 1 and 3 registered in the failure group ID 605 of the record having the service ID 3 to determine the effect of the unavailability of the DHCP server B 207 because of the failure in the connection line 215. Then, the management apparatus 100 refers to the user group information 103 and acquires information registered in the user information 403 of the records containing 1 and 3 in the group ID 400. Since the user group information 103 shown in FIG. 13C does not have any information in the user information 403 of the group ID 3, the management apparatus 100 retrieves the user ID user2 registered in the user ID 404 of the record having the group ID 1 and acquires this user ID user2 as the information on failure terminals.

At S807, the management apparatus 100 also acquires group IDs 2 and 4 registered in the quasi-failure group ID 606 of the record having the service ID 3. Then, the management apparatus 100 refers to the user group information 103 shown in FIG. 13C to acquire information registered in the user information 403 of the records containing 2 or 4 in the group ID 400 as the information on quasi-failure terminals. Specifically, it acquires the information (the user ID user1, the IP address “192.168.1.2”, and the MAC address “11.11.11.11.11.11”) registered in the user information 403 of the record having the user group ID 2 and the information (the user ID user3, the IP address “192.168.2.2”, the MAC address “33.33.33.33.33.33”, the user ID user4, the IP address “192.168.2.3”, and the MAC address “44.44.44.44.44.44”) registered in the user information 403 of the record having the user group ID 3. The information on the quasi-failure terminals includes the requirement “Request for IP address assignment” registered in the effect trigger 607 of the record having the service ID 3.

At S807, the management apparatus 100 acquires service IDs 4 and 5 registered in the failure-affected service ID 604 of the record having the service ID 3. The management apparatus 100 refers to the service information 105 and acquires “developer server 208” and “Web access 201” registered in the service providing source 601 of the records having the service ID 4 and 5 as the information on failure-affected services.

Then, the management apparatus 100 notifies the administrator of the acquired information on failure terminals, information on quasi-failure terminals, and information on failure-affected services via the network IF 117 or the man-machine IF 118 in accordance with the management apparatus configuration information 109.

At S808, since the DHCP server B 207 stored in the service providing source 601 of the record having the service ID 3 has been unable to provide the service, the management apparatus 100 enters DOWN in the operation state 602 of the record.

At S809, since the processing of S802 to S808 has been performed on all the records retrieved at S801, the management apparatus 100 terminates the processing.

When the action execution unit 115 is notified of the action IDs 3 and 4 at S804, the management apparatus 100 executes the action execution unit 115 shown in FIG. 9.

As to the processing on the action ID 3, the processing except for S907 is the same as the processing on the action ID 1; accordingly, the explanation is omitted. At S907, the management apparatus 100 makes the router 202 check the connectability with the DHCP server A 206 and holds the result of the connectability check. Because of the failure in the connection line 216 connecting the router 202 and the DHCP server A 206, the management apparatus 100 fails in the connectability check.

At S909, the management apparatus 100 performs S902 to S908 on the record having the action ID 4 retrieved at S901.

In this case, since the connectability check with the record having the action ID 3 failed at S907, the requirement registered in the execution requirement 501 “Execution of action ID 3 is failed” of the retrieved record having the action ID 4 is satisfied at S902, the management apparatus 100 proceeds to perform S903.

At S903, since the target 504 of the record having the action ID 4 includes an identifier, the management apparatus 100 proceeds to perform S904.

At S904, the management apparatus 100 sets the administrator A registered in the target 504 to the target of the action registered in the details of action 503 of the record having the action ID 4. This means that the destination to be notified by e-mail that switching to redundant service has failed is determined to be the administrator A.

At S905, since the executor apparatus 502 of the record having the action ID 4 holds the management apparatus 100, the management apparatus 100 proceeds to perform S908. At S908, the management apparatus 100 notifies the terminal such as a PC (personal computer) used by the administrator A by e-mail that the switching to redundant service has failed. It is sufficient if the administrator A is notified that the switching to redundant service has failed and may be informed by any other way than e-mail.

At S909, since the processing of S902 to S908 has been performed on all the records retrieved at S901, the management apparatus 100 terminates the processing of the action execution unit 115.

As described above, this embodiment initially groups terminals that use the services provided by service providing resources and the groups to which the terminals belong to are changed dynamically depending on the service use conditions of the terminals. Even though the service use conditions of the terminals are dynamically changed, the management apparatus 100 that has detected a failure can identify the services affected by the failure and further, accurately identify the terminals using the services.

Furthermore, this embodiment predefines processing to be executed in the event of a failure for each service, so that only the services affected by the failure undergo the processing. Consequently, the terminals using the services that are not affected by the failure are prevented from losing the services. The above example explained the case of a failure in the connection line 216; however, even in the case of a failure in an apparatus such as the DHCP server A 206, the router 202 may determine that a failure has occurred in the path to the apparatus if no response has been received from the apparatus for a predetermined time based on the protocol that periodically monitors apparatuses.

### Embodiment 2

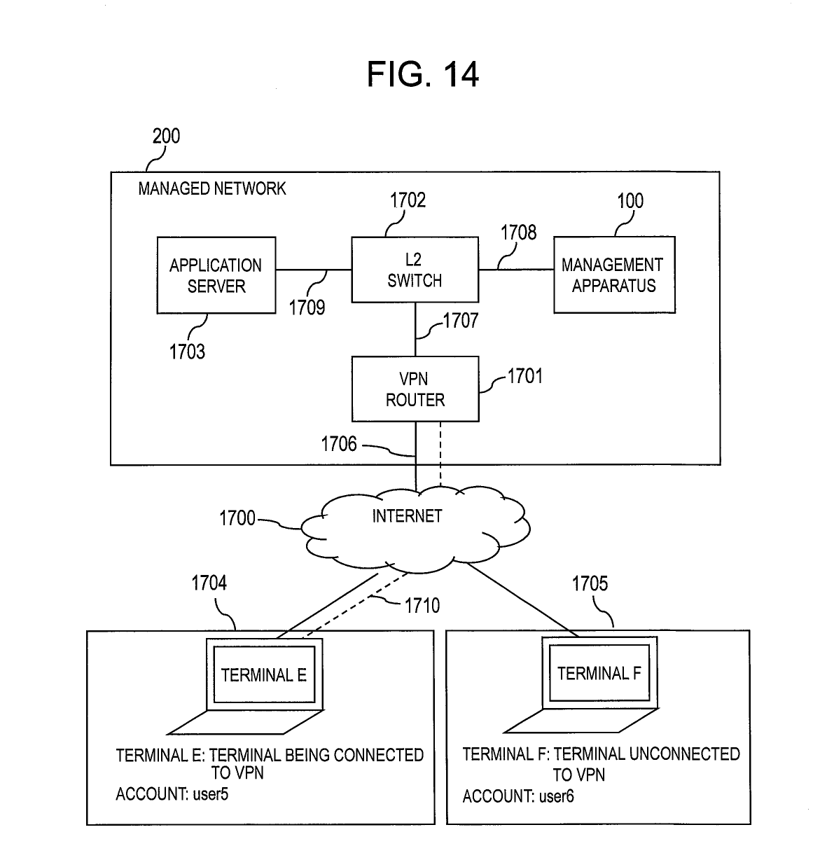

Hereinafter, Embodiment 2 of this invention is described with FIGS. 14 to 17. In Embodiment 2, the same components as those in Embodiment 1 are denoted by the same reference signs and explanation thereof is omitted.

In Embodiment 1, the management apparatus 100 dynamically manages the use conditions of terminals inside the managed network 200. In Embodiment 2, the management apparatus 100 manages the use conditions of terminals in the external of the managed network 200.

FIG. 14 is a configuration diagram of a network system in Embodiment 2 of this invention.

The network 200 managed by the management apparatus 100 includes a VPN (Virtual Private Network) router 1701, an L2 switch 1702, an application server 1703, and the management apparatus 100.

The network configuration of the managed network 200 is explained. The VPN router 1701 is connected to the Internet 1700 via a connection line 1706. The L2 switch 1702 is connected to the VPN router 1701 via a connection line 1707, to the management apparatus 100 via a connection line 1708, and to the application server 1703 via a connection line 1709. A terminal E 1704 and a terminal F 1705 are connected to the Internet 1700. In the following description, each of the terminals E 1704 and F 1705 is generally referred to as terminal. The network connected from the VPN router 1701, the L2 switch 1702, the application server 1703 and the management apparatus 100 is referred to as first network and the network connected from the terminals and differing from the first network is referred to as second network.

The VPN router 1701 authenticates terminals and configures the terminals successfully authenticated to be accessible to the managed network 200 via a VPN line 1710. In FIG. 14, the terminal E 1704 is authenticated by the VPN router 1701 and accessible to the managed network 200; the terminal F 1705 is not authenticated by the VPN router 1701 and inaccessible to the managed network 200. The VPN router 1701 is the same as the authentication server 205 in Embodiment 1 in the point that it authenticates terminals.

The application server 1703 provides a service of application to the terminals accessing the managed network 200.

The management apparatus 100 receives log information (such as syslog messages or Traps) from the apparatuses (the VPN router 1701, the L2 switch 1702, and the application server 1703) in the managed network 200 to manage these apparatuses.

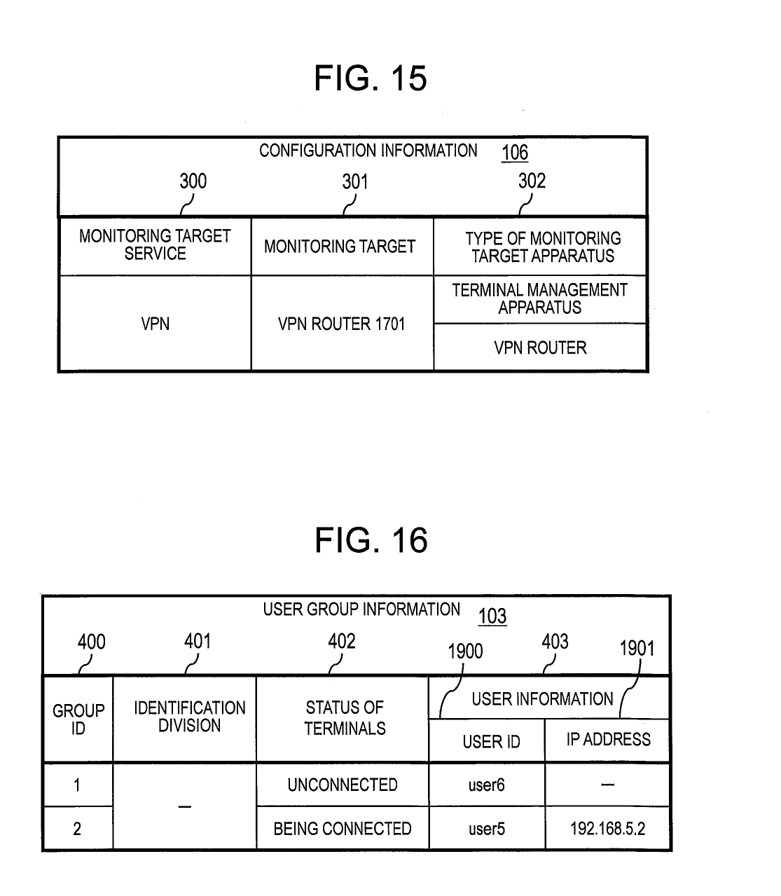

FIG. 15 is an explanatory diagram of configuration information 106 in Embodiment 2 of this invention.

The configuration information 106 includes a monitoring target service 300, monitoring targets 301, and types of monitoring target apparatuses 302, like the configuration information 106 in Embodiment 1.

In this embodiment, the monitoring target service 300 stores “VPN”. The monitoring targets 301 and the types of monitoring targets apparatus 302 store information related to “VPN”. Specifically, the monitoring target 301 stores the identifier of the VPN router 1701 and the type of monitoring apparatus 302 stores “terminal management apparatus” and “VPN router”.

FIG. 16 is an explanatory diagram of user group information 103 in Embodiment 2 of this invention.

The user group information 103 includes group IDs 400, identification divisions 401, statuses of terminals 402, and user information 403, like the user group information 103 in Embodiment 1.

The identification division 401 in this embodiment does not store anything. This is because no VLAN is configured in this embodiment.

A status of terminals 402 stores UNCONNECTED indicating that the terminal is not connected to the VPN line 1710 or CONNECTED indicating that the terminal is connected with the VPN line 1710.

User information 403 includes user IDs 1900 and IP addresses 1901. A user ID 1900 stores the identifier of a user that uses the terminal and an IP address 1901 stores the IP address of the terminal connected to the VPN line 1710.

The terminals belonging to the group 1 are the terminals connected to the VPN line 1710, or the terminals authenticated by the VPN router 1701. The terminals belonging to the group 2 are the terminals not connected to the VPN line 1710, or the terminals unauthenticated by the VPN router 1701. In this way, this embodiment groups the terminals depending on whether the terminal is connected to the VPN line 1710. Such grouping allows the management apparatus 100 to grasp the service use conditions of the terminals.

Embodiment 1 explained the user group information 103 in the case where “authentication” is registered in the monitoring target service 300 in the configuration information 106; in this embodiment, the user group information 103 is in the case where “VPN” is registered in the monitoring target service 300 in the configuration information 106, which is different from the user group information 103 in Embodiment 1 in the condition for grouping. The conditions for grouping can be different depending on the monitoring target service 300 in the configuration information 106.

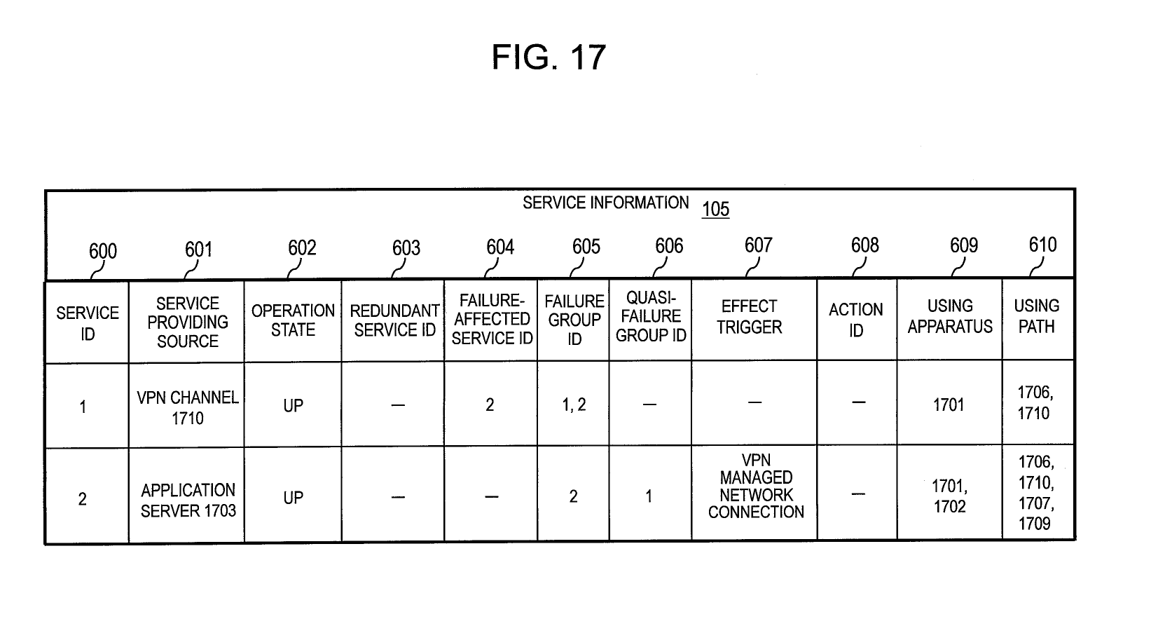

FIG. 17 is an explanatory diagram of service information 105 in Embodiment 2 of this invention.

The service information 105 includes service IDs 600, service providing sources 601, operation states 602, redundant service IDs 603, failure-affected service IDs 604, failure group IDs 605, quasi-failure group IDs 606, effect triggers 607, action IDs 608, using apparatuses 609, and using paths 610, like the service information 105 shown in FIG. 6 in Embodiment 1.

The difference of the service information 105 in this embodiment from the service information 105 in Embodiment 1 is that the VPN line 1710 is registered in a service providing source 601 and a using path 610. That is to say, the VPN line 1710 is a network path as well as a resource for providing a service to terminals.

When terminals become unable to use the VPN line 1710 because of an effect of a failure in the external of the managed network 200, the management apparatus 100 cannot address the failure in the external of the managed network 200 unless the VPN line 1710 is registered in the using path 610. For this reason, the VPN line 1710 is registered in the using path 610.

The VPN line 1710 is also registered in the service providing source 601 in order to accurately grasp the terminals using the VPN line 1710 in the event of a failure in the VPN line 1710.

Next, described is the processing of the management apparatus 100 when terminals become unable to use the VPN line 1710 because of an effect of a failure in an apparatus in the Internet 1700 which is the external of the managed network 200.

The VPN router 1701 cannot recognize the failure in the apparatus in the external of the managed network 200 but detects disconnection of the VPN line 1710 caused by the failure. In such an event, the VPN router 1701 sends log information indicating that a failure has occurred in the VPN line 1710 to the management apparatus 100.

Upon receipt of the log information sent from the VPN router 1701, the management apparatus 100 executes the received information analysis unit 112 shown in FIG. 7. In this processing of the received information analysis unit 112, the management apparatus 100 notifies the failure range analysis unit 114 of the failure point (the VPN line 1710) at S705.

When the failure range analysis unit 114 is notified of the failure point, the management apparatus 100 executes the failure range analysis unit 114 shown in FIG. 8.

At S801, the management apparatus 100 refers to the service information 105 and retrieves the records having the service IDs 1 and 2 holding the identifier of the VPN line 1710 in the using path 610.

At S802, since the operation state 602 of the record of the service ID 1 holds UP, the management apparatus 100 proceeds to perform S803. At S803, since the action ID 608 of the record of the service ID 1 does not hold any identifier, the management apparatus 100 proceeds to perform S805. At S805, since the redundant service ID 603 of the record having the service ID 1 does not hold any identifier, the management apparatus 100 proceeds to perform S807.

At S807, the management apparatus 100 acquires group IDs 1 and 2 registered in the failure group ID 605 of the record having the service ID 1 to determine the effect of the unavailability of the VPN line 1710 because of the failure. Then, the management apparatus 100 refers to the user group information 103 shown in FIG. 16 and acquires information registered in the user information 403 of the records containing 1 or 2 in the group ID 400. Specifically, the management apparatus 100 acquires the user ID user6 registered in the user ID 1900 of the record having the group ID 1, the user ID user5 registered in the user ID 1900 of the record having the group ID 2, and the IP address “192.168.5.2” registered in the IP address 1901 of the record having the group ID 2 as the information on failure terminals.

In the meanwhile, the management apparatus 100 does not acquire any information on quasi-failure terminals at S807 since the quasi-failure group ID 606 of the record having the service ID 1 does not hold anything.

At S807, the management apparatus 100 further acquires a service ID 2 registered in the failure-affected service ID 604 of the record having the service ID 1. The management apparatus 100 acquires “application server 1703” registered in the service providing source 601 of the records having the service ID 2 as the information on failure-affected services.

Then, at S807, the management apparatus 100 notifies the administrator of the acquired information on failure terminals and information on failure-affected services via the network IF 117 or the man-machine IF 118 in accordance with the management apparatus configuration information 109.

At S808, since the VPN line 1710 registered in the service providing source 601 of the record having the service ID 1 has been unable to provide the service, the management apparatus 100 enters DOWN in the operation state 602 of the record.

At S809, since the processing of S802 to S808 has not been performed on the record having the service ID 2, the management apparatus 100 performs the processing of S802 to S808 on the record of the service ID 2. Since the processing of S802 to S805 and S808 is the same as the foregoing processing on the record of the service ID 1, the explanation thereof is omitted.

At S807, the management apparatus 100 acquires a group ID 2 registered in the failure group ID 605 of the record having the service ID 2 to determine the effect of the unavailability of the application server 1703 because of the failure. Then, the management apparatus 100 refers to the user group information 103 shown in FIG. 16 and acquires information registered in the user information 403 of the record containing 2 in the group ID 400. Specifically, the management apparatus 100 acquires the user ID user5 registered in the user ID 1900 of the record having the group ID 2 and the IP address “192.168.5.2” registered in the IP address 1901 of the record having the group ID 2 as the information on failure terminals.

At S807, the management apparatus 100 further acquire a group ID 1 registered in the quasi-failure terminal 606 of the record of the service ID 2. Then, the management apparatus 100 refers to the user group information 103 to acquire the information registered in the user information 403 of the record having the group ID 400 of 1 as the information on quasi-failure terminals. Specifically, the information (user ID user6) registered in the user information 403 of the record of the group ID 1 is acquired. The information on quasi-failure terminals includes the requirement “VPN managed network connection” registered in the effect trigger 607 of the record of the service ID 1.

At S807, the management apparatus 100 does not acquire information on failure-affected services since the failure-affected service ID 604 of the record having the service ID 2 does not hold anything.

Then, at S807, the management apparatus 100 notifies the administrator of the acquired information on failure terminals and information on quasi-failure terminals via the network IF 117 or the man-machine IF 118 in accordance with the management apparatus configuration information 109.

According to this embodiment, even in the case where the terminals are located in the external of the managed network 200, the management apparatus 100 that has detected a failure can determine the services affected by the failure and further, accurately determine the terminals using the services.

This invention is not limited to the above-described embodiments but includes various modifications. The above-described embodiments are explained in details for better understanding of this invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, processing units, and processing means, for all or a part of them, may be implemented by hardware: for example, by designing an integrated circuit. The above-described configurations and functions may be implemented by software, which means that a processor interprets and executes programs providing the functions. The information of programs, tables, and files to implement the functions may be stored in a storage device such as a memory, a hard disk drive, or an SSD (Solid State Drive), or a storage medium such as an IC card, an SD card, or a DVD.

What is claimed is:

1. A management apparatus connected to terminals and service providing resources for providing services to be used by the terminals via a network, the management apparatus comprising:
user group information for managing the terminals by grouping the terminals into groups each corresponding to service use conditions of terminals belonging to the group; and
service information for associating each of the services provided by the service providing resources with paths for passing data when a terminal uses the service and a failure group which is affected by a failure when the failure occurs in one of the paths,
wherein, when a failure occurs in one of the paths in the network, the management apparatus refers to the service information to identify a service for which the paths in the service information include the failed path as a failed service,
wherein the management apparatus identifies a failure group associated with the identified failed service,
wherein the management apparatus refers to the user group information to identify terminals belonging to the identified failure group as failure terminals, and
wherein the management apparatus reports the identified failure terminals.

2. A management apparatus according to claim 1,
wherein the service providing resources include an authentication apparatus for authenticating users of the terminals,
wherein the groups to which the terminals belong include a first group to which terminals of unauthenticated users belong and a second group to which terminals of authenticated users belong, and
wherein, upon receipt of authentication log information sent from the authentication apparatus when the authentication apparatus has authenticated a user of a terminal, the management apparatus updates the user group information in such a manner that the terminal of the authenticated user belongs to the second group.

3. A management apparatus according to claim 2,
wherein the management apparatus accepts entry of authentication information related to the authentication of the user of the terminal, and
wherein the management terminal registers the accepted authentication information in the authentication apparatus.

4. A management apparatus according to claim 1,
wherein the service information further associates each of the services with processing to be executed when a failure occurs in one of the paths,
wherein the management apparatus identifies processing to be executed associated with the identified failed service, and
wherein the management apparatus executes the identified processing.

5. A management apparatus according to claim 1,
wherein the service information further associates each of the services with a failure-affected service which will be unavailable by an effect of a failed service when the failure occurs in one of the paths,
wherein, upon identification of the failed service, the management apparatus refers to the service information to identify a failure-affected service associated with the failed service, and
wherein the management apparatus reports the identified failure terminals and the identified failure-affected service.

6. A management apparatus according to claim 1,
wherein the service information further associates each of the services with a quasi-failure group which will be affected by a failure when the failure occurs in one of the paths and a predetermined requirement is satisfied,
wherein, upon identification of the failed service, the management apparatus refers to the service information to identify a quasi-failure group associated with the failed service,
wherein the management apparatus refers to the user group information to identify terminals belonging to the identified quasi-failure group as quasi-failure terminals, and
wherein the management apparatus reports the identified failure terminals and the identified quasi-failure terminals.

7. A management method for a management apparatus connected to terminals, service providing resources for providing services to be used by the terminals via a network to manage the terminals, the service providing resources, and the network,
the management apparatus including:
user group information for managing the terminals by grouping the terminals into groups each corresponding to service use conditions of terminals belonging to the group; and
service information for associating each of the services provided by the service providing resources with paths for passing data when a terminal uses the service and a failure group which is affected by a failure when the failure occurs in one of the paths,
the management method comprising:
referring to, by the management apparatus, the service information upon occurrence of a failure in one of the paths in the network to identify a service for which the paths in the service information include the failed path as a failed service;
identifying, by the management apparatus, a failure group associated with the identified failed service;
referring to, by the management apparatus, the user group information to identify terminals belonging to the identified failure group as failure terminals; and
reporting, by the management apparatus, the identified failure terminals.

8. A management method according to claim 7,
wherein the service providing resources include an authentication apparatus for authenticating users of the terminals,
wherein the groups to which the terminals belong include a first group to which terminals of unauthenticated users belong and a second group to which terminals of authenticated users belong, and
wherein the management method further comprises:
updating, by the management apparatus, the user group information in such a manner that the terminal of the authenticated user belongs to the second group upon receipt of authentication log information sent from the authentication apparatus when the authentication apparatus has authenticated a user of a terminal.

9. A management method according to claim 8, further comprising:
accepting, by the management apparatus, entry of authentication information related to the authentication of the user of the terminal; and
registering, by the management terminal, the accepted authentication information in the authentication apparatus.

10. A management method according to claim 7,
wherein the service information further associates each of the services with processing to be executed when a failure occurs in one of the paths,
wherein the management method further comprises:
identifying, by the management apparatus that has identified the failed service, processing to be executed associated with the identified failed service; and
executing, by the management apparatus, the identified processing.

11. A management method according to claim 7,
wherein the service information further associates each of the services with a failure-affected service which will be unavailable by an effect of a failed service when the failure occurs in one of the paths,
wherein the management method further comprises:
referring to, by the management apparatus that has identified the failed service, the service information to identify a failure-affected service associated with the failed service; and
reporting, by the management apparatus, the identified failure terminals and the identified failure-affected service.

12. A management method according to claim 7,
wherein the service information further associates each of the services with a quasi-failure group which will be affected by a failure when a predetermined requirement is satisfied after the failure occurs in one of the paths,
wherein the management method further comprises:
referring to, by the management apparatus that has identified the failed service, the service information to identify a quasi-failure group associated with the failed service;
referring to, by the management apparatus, the user group information to identify terminals belonging to the identified quasi-failure group as quasi-failure terminals; and
reporting, by the management apparatus, the identified failure terminals and the identified quasi-failure terminals.
